(19) United States
(12) Patent Application Publication
(10) Pub. No.: US 2012/0210261 A1
(43) Pub. Date: Aug. 16, 2012

(54) SYSTEMS, METHODS, AND COMPUTER-READABLE MEDIA FOR CHANGING GRAPHICAL OBJECT INPUT TOOLS

(75) Inventors: Matthew Jacob Sarnoff, San Francisco, CA (US); Conrad R. Carlen, Burlingame, CA (US)

(73) Assignee: Apple Inc., Cupertino, CA (US)

(21) Appl. No.: 13/029,093

(22) Filed: Feb. 16, 2011

Related U.S. Application Data
(60) Provisional application No. 61/442,021, filed on Feb. 11, 2011.

(51) Int. Cl. G06F 3/048

(52) U.S. Cl. 715/765

(57) ABSTRACT

Systems, methods, and computer-readable media for changing graphical object input tools are provided. For example, input tool content may be defined with multiple input tool properties, and then an input tool indicative of at least a first of the input tool properties may be rendered on a display. The first input tool property may be changed based on an input gesture, and the input tool may be re-rendered on the display after the change. The input gesture may be a multi-touch input gesture, the input gesture may be independent of any menu provided on the display, or the input gesture may be indicative of at least one position on the display where the input tool is initially rendered. A graphical object, such as a drawing stroke or a text string, may be rendered on the display using the input tool.

### CROSS-REFERENCE TO RELATED APPLICATION

This application claims the benefit of U.S. Provisional Patent Application No. 61/442,021, filed Feb. 11, 2011, which is hereby incorporated by reference herein in its entirety.

### FIELD OF THE INVENTION

This can relate to systems, methods, and computer-readable media for generating graphical object data and, more particularly, to systems, methods, and computer-readable media for changing graphical object input tools using an electronic device.

### BACKGROUND OF THE DISCLOSURE

Some electronic devices include a graphical display system for generating and presenting graphical objects, such as free-form drawing strokes, strings of text, and drawing shapes, on a display. A user of such devices may interact with the graphical display system via a user interface to select certain properties of a graphical object to be generated as well as to select at least one position on a display at which the generated graphical object is to be presented. However, currently available electronic devices may limit the ways by which a user may alter certain properties of a graphical object via the interface.

### SUMMARY OF THE DISCLOSURE

Systems, methods, and computer-readable media for changing graphical object input tools are provided.

A graphical object input tool may be an indicator that may be generated and presented on a display by a virtual drawing space application to show the current insertion point for new graphical object data that may be created by the input tool on the display. New graphical object data that may be generated using an input tool may be any suitable type of graphical data, such as a drawing stroke, a string of text, or a drawing shape. In some embodiments, at least one visual characteristic or property of an input tool may be indicative of a particular property of new graphical object data that may be inserted or otherwise presented at the tool's position on the display. For example, the size of the input tool may be indicative of or may otherwise correspond to the size of a graphical object that may be inserted on the display at the tool's position. However, the substance of a graphical object may determine or otherwise define other properties of the graphical object that may not be based on properties of an associated input tool, such as the trail of a drawing stroke graphical object to be generated by an input tool along the display or the alphanumeric character content of a text string graphical object to be inserted by an input tool on the display.

Various user input gestures may be provided to directly interact with a displayed input tool for changing various properties of the input tool. For example, rather than having to select options on a displayed menu, a user may provide input gestures at or near a displayed input tool to directly manipulate one or more properties of that input tool, such as its size or color. By visually changing how an input tool is represented on a user workspace so as to indicate a change in an input tool property, a user may be provided with a more efficient and intuitive user interface for generating graphical objects. Moreover, by allowing a user to change an input tool property using an input gesture that may be independent of any displayed menu, the user may be allowed to focus directly on the input tool being used to generate the graphical object, for example, without a user having to periodically move his or her attention away from the input tool and towards a menu for altering an input tool property. Such an input gesture may be a multi-touch input gesture or an input gesture with a position that is directly associated with a position of an input tool presented on a display.

For example, in some embodiments, there is provided a method for generating graphical object data. The method may include defining input tool content with multiple input tool properties and initially rendering on a display an input tool that is indicative of at least a first input tool property of the multiple of input tool properties. The method may also include receiving an input gesture, changing the first input tool property based on the input gesture, and re-rendering the input tool on the display after the changing. In some embodiments, the received input gesture may be a multi-touch input gesture, such as a multi-touch rotate input gesture that may change an orientation input tool property of the input tool content, or such as a multi-touch pinch or pull input gesture that may change a size input tool property of the input tool content. In some embodiments, the received input gesture may be independent of any menu provided on the display. As another example, the received input gesture may be indicative of at least one position on the display where the input tool is initially rendered. This may provide the user with a greater sense of control over the input tool and its various input tool properties.

This method may also include receiving substance information and rendering a graphical object on the display based on the substance information and the input tool content. The substance information may be information defining a trail along which stamp input content may be applied for generating a drawing stroke graphical object. Alternatively, the substance information may be information defining a character that may be rendered at the position of the input tool according to one or more input tool properties of the input tool content.

In other embodiments, there is provided a method of generating a graphical object that includes defining input tool content with multiple input tool properties. The method also includes presenting on a display an input tool indicative of at least a first input tool property of the input tool properties, and moving the input tool along a trail on the display from a first trail position to a second trail position. The method may also include presenting a first portion of the graphical object on the display by applying the input tool content at the first trail position when the input tool is at the first trail position, and presenting a second portion of the graphical object on the display by applying the input tool content at the second trail position when the input tool is at the second trail position. Moreover, the method may include changing at least a second input tool property of the input tool properties during the moving between the first trail position and the second trail position. Therefore, a property of the graphical object may change as the input tool is moved along the trail due to the changing of the second input tool property. In some embodiments, the first input tool property may be the second input tool property, such as a size property.

In some embodiments, the moving of this method may include moving the input tool along the trail in response to receiving a user input gesture on a touch component. For example, the user input gesture may include a user dragging a user touch event along the touch component, and the changing of this method may include changing the second input tool property in response to the user altering the pressure applied by the user touch event while dragging the touch event along the touch component. As another example, the user input gesture may include a user dragging two fingers along the touch component, and the changing of this method may include changing the second input tool property in response to the user pinching, pulling, or rotating the two fingers while dragging the two fingers along the touch component.

In yet other embodiments, there is provided a graphical display system that may include a display and an input tool defining module that may generate input tool content and receive a first multi-touch input gesture for changing a first input tool property of the input tool content. The system may also include a substance defining module that may generate substance content based on substance information and the input tool content. Moreover, the system may include a processing module that may present on the display an input tool based on the first input tool property and that may present on the display a graphical object based on the substance content and the input tool content. The multi-touch input gesture may be a rotate gesture, a pinch gesture, or a pull gesture, that may change a size of the input tool or another visual characteristic of the input tool. At least one the positions of the multi-touch input gesture may be independent of any menu on the display or shared by the input tool presented on the display. In some embodiments, the substance information may define a trail along the display, and at least one touch event of the input gesture may generate at least a portion of the substance information.

In still yet other embodiments, there is provided computer-readable media for controlling an electronic device. The computer-readable media may include computer-readable code recorded thereon for defining input tool content with multiple input tool properties and for initially rendering on a display an input tool that is indicative of at least a first input tool property of the multiple input tool properties. The computer-readable media may also include computer-readable code recorded thereon for receiving a multi-touch input gesture, changing the first input tool property based on the input gesture, and re-rendering the input tool on the display after the changing.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters refer to like parts throughout, and in which:

FIG. 1 is a schematic view of an illustrative electronic device for changing graphical object input tools, in accordance with some embodiments of the invention;

FIG. 2 is a schematic view of an illustrative portion of the electronic device of FIG. 1, in accordance with some embodiments of the invention;

FIGS. 3A-3K are front views of the electronic device of FIGS. 1 and 2, presenting exemplary screens of displayed graphical data, in accordance with some embodiments of the invention; and

FIGS. 4 and 5 are flowcharts of illustrative processes for changing graphical object input tools, in accordance with some embodiments of the invention.

### DETAILED DESCRIPTION OF THE DISCLOSURE

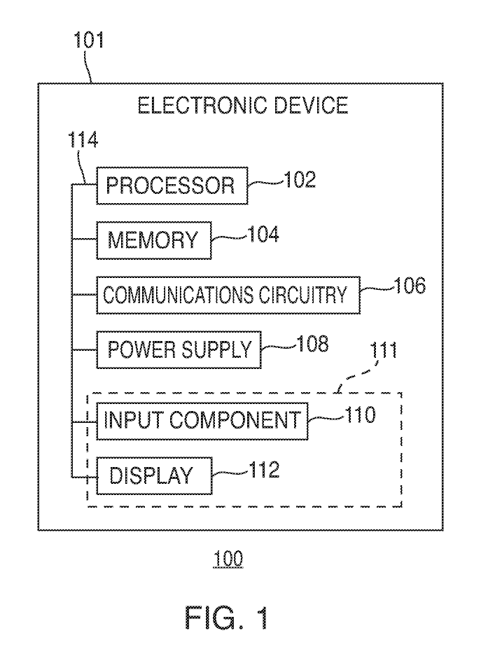

Systems, methods, and computer-readable media for changing graphical object input tools are provided and described with reference to FIGS. 1-5.

FIG. 1 is a schematic view of an illustrative electronic device 100 for dynamically changing graphical object input tools in accordance with some embodiments of the invention. Electronic device 100 may be any portable, mobile, or hand-held electronic device configured to change graphical object input tools wherever the user travels. Alternatively, electronic device 100 may not be portable at all, but may instead be generally stationary. Electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet, server, etc.), monitor, television, stereo equipment, set up box, set-top box, boom box, modem, router, printer, and combinations thereof. In some embodiments, electronic device 100 may perform a single function (e.g., a device dedicated to changing graphical object input tools) and, in other embodiments, electronic device 100 may perform multiple functions (e.g., a device that changes graphical object input tools, plays music, and receives and transmits telephone calls).

Electronic device 100 may include a processor or control circuitry 102, memory 104, communications circuitry 106, power supply 108, input component 110, and display 112. Electronic device 100 may also include a bus 114 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 1. For example, electronic device 100 may include motion-sensing circuitry, a compass, positioning circuitry, or several instances of the components shown in FIG. 1. For the sake of simplicity, only one of each of the components is shown in FIG. 1.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 106 may be provided to allow device 100 to communicate with one or more other electronic devices or servers using any suitable communications protocol. For example, communications circuitry 106 may support Wi-Fi (e.g., an 802.11 protocol), Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof. Communications circuitry 106 may also include circuitry that can enable device 100 to be electrically coupled to another device (e.g., a host computer or an accessory device) and communicate with that other device, either wirelessly or via a wired connection.

Power supply 108 may provide power to one or more of the components of device 100. In some embodiments, power supply 108 can be coupled to a power grid (e.g., when device 100 is not a portable device, such as a desktop computer). In some embodiments, power supply 108 can include one or more batteries for providing power (e.g., when device 100 is a portable device, such as a cellular telephone). As another example, power supply 108 can be configured to generate power from a natural source (e.g., solar power using solar cells).

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, proximity sensor, light detector, motion sensors, and combinations thereof. Each input component 110 can be configured to provide one or more dedicated control functions for making selections or issuing commands associated with operating device 100.

Electronic device 100 may also include one or more output components that may present information (e.g., graphical, audible, and/or tactile information) to a user of device 100. An output component of electronic device 100 may take various forms, including, but not limited to, audio speakers, headphones, audio line-outs, visual displays, antennas, infrared ports, rumblers, vibrators, or combinations thereof.

For example, electronic device 100 may include display 112 as an output component. Display 112 may include any suitable type of display or interface for presenting visual data to a user. In some embodiments, display 112 may include a display embedded in device 100 or coupled to device 100 (e.g., a removable display). Display 112 may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof. Alternatively, display 112 can include a movable display or a projecting system for providing a display of content on a surface remote from electronic device 100, such as, for example, a video projector, a head-up display, or a three-dimensional (e.g., holographic) display. As another example, display 112 may include a digital or mechanical viewfinder, such as a viewfinder of the type found in compact digital cameras, reflex cameras, or any other suitable still or video camera.

In some embodiments, display 112 may include display driver circuitry, circuitry for driving display drivers, or both. Display 112 can be operative to display content (e.g., media playback information, application screens for applications implemented on electronic device 100, information regarding ongoing communications operations, information regarding incoming communications requests, device operation screens, etc.) that may be under the direction of processor 102. Display 112 can be associated with any suitable characteristic dimensions defining the size and shape of the display. For example, the display can be rectangular or have any other polygonal shape, or alternatively can be defined by a curved or other non-polygonal shape (e.g., a circular display). Display 112 can have one or more primary orientations for which an interface can be displayed, or can instead or in addition be operative to display an interface along any orientation selected by a user.

It should be noted that one or more input components and one or more output components may sometimes be referred to collectively herein as an input/output (“I/O”) component or I/O interface (e.g., input component 110 and display 112 as I/O component or I/O interface 111). For example, input component 110 and display 112 may sometimes be a single I/O component 111, such as a touch screen, that may receive input information through a user's touch of a display screen and that may also provide visual information to a user via that same display screen.

Processor 102 of device 100 may include any processing circuitry operative to control the operations and performance of one or more components of electronic device 100. For example, processor 102 may be used to run operating system applications, firmware applications, media playback applications, media editing applications, or any other application. In some embodiments, processor 102 may receive input signals from input component 110 and/or drive output signals through display 112. Processor 102 may load a user interface program (e.g., a program stored in memory 104 or another device or server) to determine how instructions or data received via an input component 110 may manipulate the way in which information is stored and/or provided to the user via an output component (e.g., display 112). Electronic device 100 (e.g., processor 102, memory 104, or any other components available to device 100) may be configured to process graphical data at various resolutions, frequencies, intensities, and various other characteristics as may be appropriate for the capabilities and resources of device 100.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

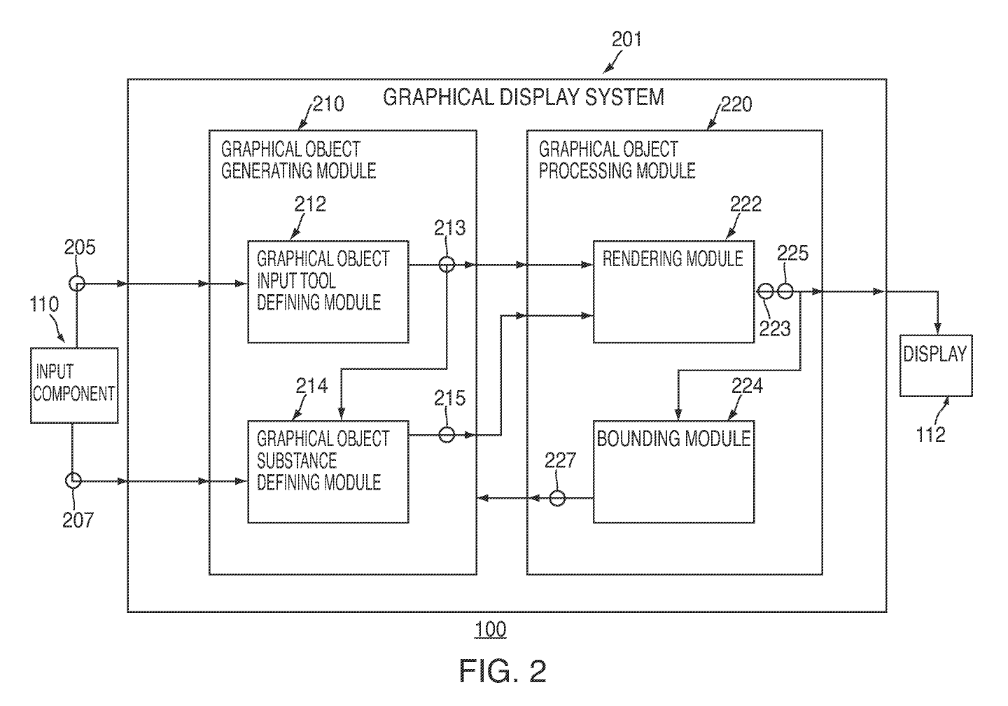

FIG. 2 shows a schematic view of a graphical display system 201 of electronic device 100 that may be provided to generate and manipulate graphical data for presentation on display 112. For example, in some embodiments, graphical display system 201 may generate and manipulate graphical data representations of two-dimensional and/or three-dimensional objects that may define at least a portion of a visual screen of information to be presented as an image on a display, such as display 112. Graphical display system 201 may be configured to generate and manipulate realistic animated images in real time (e.g., using about 30 or more screens or frames per second) for presentation to a user on display 112.

As shown in FIG. 2, for example, graphical display system 201 may include a graphical object generating module 210 that may define and generate at least a portion of the graphical contents of each of the screens to be rendered for display. Such graphical screen contents may be based on the one or more applications being run by electronic device 100 as well as any input instructions being received by device 100 (e.g., via input component 110). The graphical screen contents can include video data based on images of a video program, background image content (e.g., photographic images), free-form drawing strokes, textual information (e.g., one or more alphanumeric characters), drawing objects, and combinations thereof. For example, an application run by electronic device 100 may be any suitable application that may provide a virtual drawing space on which a user may create and manipulate graphical objects, such as text strings, drawing shapes, and free-form drawing strokes (e.g., Illustrator™ or Photoshop™ by Adobe Systems Incorporated or Microsoft Paint™ by Microsoft Corporation). Graphical object generating module 210 may define and generate at least some of these types of graphical objects to be rendered for display by graphical display system 201. For example, graphical object generating module 210 may define and generate drawing stroke graphical objects, text string graphical objects, and drawing shape graphical objects[?] to be rendered for display by graphical display system 201 on display 112 of electronic device 100.

In some embodiments, graphical object generating module 210 may include a graphical object input tool defining module 212 that may define and generate a graphical object input tool to be presented on display 112 for helping a user create a graphical object. A graphical object input tool may be a visually distinct mark or any other suitable indicator that may be generated and presented on a display to show the current insertion point for new data or instructions on the display. The position of the input tool on the display may be changed by a user (e.g., via input component 110) or by an application running on device 100. The position of the input tool on the display may also change from a previous input tool position to a new input tool position when new graphical object data is inserted on the display at the previous input tool position. In some embodiments, at least one visual characteristic or property of an input tool may be indicative of a particular type or substance of new data that may be inserted or otherwise presented at the tool's position on the display. For example, the size of the input tool may be indicative of or may otherwise correspond to the size of a graphical object that may be inserted on the display at the tool's position. Additionally or alternatively, at least one visual characteristic or property of an input tool may be indicative of a particular type of data that may already be present at the tool's position on the display. For example, an input tool may be represented by a vertical cursor when the input tool hovers over text on the display, and the input tool may be represented by a hand with an outstretched index finger when the input tool hovers over a hyperlink on the display.

Graphical object input tool defining module 212 may receive graphical object input tool information 205 from various input sources for defining one or more input tool properties of a graphical object input tool that may be generated and presented on display 112. For example, such input sources may be the one or more applications being run by electronic device 100 and/or any user input instructions being received by device 100 (e.g., via input component 110, as shown in FIG. 2). Based on the received graphical object input tool information 205, graphical object input tool defining module 212 may generate appropriate graphical object input tool content 213. In some embodiments, input tool defining module 212 may constantly update input tool content 213 based on any new input tool information 205 received by input tool defining module 212. Such graphical object input tool content 213 may then be utilized for presenting on display 112 a visually distinct mark, or any other suitable indicator, that may be representative of the defined input tool. Such a visualization of the input tool may include at least one visual characteristic indicative of a particular input tool property that any new data generated by the input tool may share.

In some embodiments, graphical object generating module 210 may also include a graphical object substance defining module 214 that may define and generate the substance or content of a graphical object to be presented on display 112 using an associated input tool. The substance of a graphical object may be any suitable type of graphical data, such as a drawing stroke, a string of text, a drawing shape, and the like. In some embodiments, the substance of a graphical object may be at least partially based on one or more properties of an associated graphical object input tool. For example, if a particular input tool has been generated to have a certain color property, then a graphical object created by a user in association with that input tool may have the same particular color property as that tool. However, the substance of a graphical object may determine or otherwise define other properties of the graphical object that may not be based on properties of an associated input tool, such as the trail of a drawing stroke graphical object along the display or the alphanumeric character content of a text string graphical object.

Graphical object substance defining module 214 may receive graphical object substance information 207 from various input sources for defining one or more substance properties of the substance of a graphical object that may be generated and presented on display 112. For example, such input sources may be the one or more applications being run by electronic device 100 and/or any user input instructions being received by device 100 (e.g., via input component 110, as shown in FIG. 2). Graphical object substance defining module 214 may generate appropriate graphical object substance content 215 based on the received graphical object substance information 207. In some embodiments, graphical object substance defining module 214 may generate the appropriate graphical object substance content 215 based also on graphical object input tool content 213. Such graphical object substance content 215 may then be utilized for presenting on display 112 a graphical object that may be defined by the one or more substance properties defined by substance information 207 and that may share or also be defined by at least one input tool property of an associated input tool defined by graphical object input tool information 205 (e.g., as provided by graphical object input tool content 213).

As shown in FIG. 2, for example, graphical display system 201 may also include a graphical object processing module 220 that may process the graphical object content generated by graphical object generating module 210 (e.g., graphical object input tool content 213 and/or graphical object substance content 215) such that a graphical object may be presented to a user on display 112 of device 100. In some embodiments, as shown in FIG. 2, for example, graphical object processing module 220 may include a rendering module 222. Rendering module 222 may be configured to render the graphical screen content information for the graphical object content information generated by graphical object generating module 210, and may therefore be configured to provide rendered graphical object data for presentation on display 112 (e.g., rendered graphical object input tool data 223 based on graphical object input tool content 213 and/or rendered graphical object substance data 225 based on graphical object substance content 215).

For example, rendering module 222 may be configured to perform various types of graphics computations or processing techniques and/or implement various rendering algorithms on the graphical object content information generated by graphical object generating module 210 so that rendering module 222 may render the graphical data necessary to define at least a portion of the image to be displayed on display 112 (e.g., the graphical object portion of the image). Such processing may include, but is not limited to, matrix transformations, scan-conversions, various rasterization techniques, various techniques for three-dimensional vertices and/or three-dimensional primitives, texture blending, and the like.

Rendered graphical object data generated by rendering module 222 (e.g., rendered graphical object input tool data 223 and/or rendered graphical object substance data 225) may include one or more sets of pixel data, each of which may be associated with a respective pixel to be displayed by display 112 when presenting a graphical object portion of that particular screen's visual image to a user of device 100. For example, each of the sets of pixel data included in the rendered graphical object data generated by rendering module 222 may be correlated with coordinate values that identify a particular one of the pixels to be displayed by display 112, and each pixel data set may include a color value for its particular pixel as well as any additional information that may be used to appropriately shade or provide other cosmetic features for its particular pixel. A portion of this pixel data for rendered graphical object input tool data 223 may represent at least a portion of the graphical object input tool content 213 for a particular input tool (e.g., a stamp input tool for a drawing stroke graphical object or a cursor input tool for a text string graphical object). As another example, a portion of this pixel data for rendered graphical object substance data 225 may represent at least a portion of the graphical object substance content 215 for the substance of a particular graphical object (e.g., a trail of an applied stamp for a drawing stroke graphical object or a glyph at a cursor for a text string graphical object).

Rendering module 222 may be configured to transmit the pixel data sets of the rendered graphical object data for a particular screen to display 112 via any suitable process for presentation to a user. Moreover, rendering module 222 may transmit the rendered graphical object data (e.g., rendered data 223 and/or rendered data 225) to a bounding module 224 of graphical object processing module 220. Based on the rendered graphical object data, bounding module 224 may generate bounding area information 227 that may be indicative of one or more particular areas of the screen presented by display 112. For example, bounding area information 227 may be indicative of the particular pixel area of a display screen that is presenting the graphical object input tool content 213 of rendered graphical object input tool data 223 (e.g., such that system 201 may know what area of the screen may need to be re-rendered if the tool is moved or if the tool is used to create a graphical object). Alternatively or additionally, bounding area information 227 may be indicative of the particular pixel area of a display screen that is presenting the graphical object substance content 215 of rendered graphical object substance data 225. Bounding area information 227 may be compared with user input information indicative of a user interaction with a displayed graphical object or displayed input tool, and such a comparison may help determine with which particular portion of the graphical object or input tool the user is intending to interact.

For example, when graphical object generating module 210 is generating a drawing stroke graphical object, graphical object input tool defining module 212 may define a drawing stroke input tool to be a stamp with a particular set of stamp properties. Such a stamp may define a particular type of pixel data to be applied on a display when the stamp is used for creating a drawing stroke graphical object. Graphical object substance defining module 214 may define the substance of a drawing stroke graphical object to be a trail with a particular set of trail properties. Such a trail may define a path on the display along which an associated stamp may repeatedly apply its pixel data for generating a drawing stroke graphical object on the display.

Graphical object input tool defining module 212 may receive various types of drawing stroke graphical object input tool information 205, such as a selection of one or more particular properties or characteristics, that may be used to define a stamp with a particular set of stamp properties. For example, a stamp drawing stroke input tool may be defined by any suitable stamp property or set of stamp properties including, but not limited to, shape, size, pattern, orientation, hardness, color, transparency, spacing, and the like. In some embodiments, a user of device 100 may select at least one of the stamp properties that may be used by graphical object input tool defining module 212 to define a stamp drawing stroke input tool for a drawing stroke graphical object. For example, a user may interact with one or more drawing applications running on device 100 via input component 110 to generate drawing stroke input tool information 205 for defining one or more of the stamp properties. Alternatively or additionally, in other embodiments, an application running on device 100 may be configured to automatically generate at least a portion of drawing stroke input tool information 205 for defining one or more of the stamp properties of a stamp drawing stroke input tool.

Once drawing stroke input tool information 205 has been received, graphical object input tool defining module 212 may generate appropriate drawing stroke graphical object input tool content 213 based on the drawing stroke input tool information 205. For example, such drawing stroke input tool content 213 may be at least a partial representation of an appropriate stamp based on the selected stamp properties. For example, each possible combination of selectable stamp properties can define a different particular stamp, and each stamp can be generated using any suitable approach. In some embodiments, a stamp can be generated using an 8-bit bitmap that may be associated with one or more particular stamp properties. In another embodiment, a stamp can be generated using path data that may be associated with a stamp input tool of a particular stamp shape property but that can be resized based on the selected stamp size property. In some embodiments, graphical object input tool defining module 212 may include or may have access to a stamp repository or database that may have stored therein stamps for some or all drawing input tools of some or all possible stamp properties, and graphical object input tool defining module 212 may select particular stamps from the stamp database in response to received drawing stroke input tool information 205.

Although drawing stroke input tool content 213 may be generated as a complete representation of an appropriate stamp based on all of the selected stamp properties, only a portion of such a representation provided by stamp input tool content 213 may actually be utilized for presentation on display 112 as a visually distinct mark for representing the defined stamp input tool. For example, such a partial visualization of the stamp input tool may include at least one visual characteristic indicative of at least one particular stamp input tool property that any new data (e.g., a new drawing stroke graphical object) generated by the input tool may share. However, such a partial visualization of the stamp input tool may not include a visual characteristic indicative of at least one other particular stamp input tool property, although that particular stamp input tool property may still be shared by any new data generated by the stamp input tool. Rendering module 222 may render at least a portion of graphical object input tool content 213 as rendered graphical object input tool data 223, such that the graphical object input tool content may be presented to a user on display 112 of device 100.

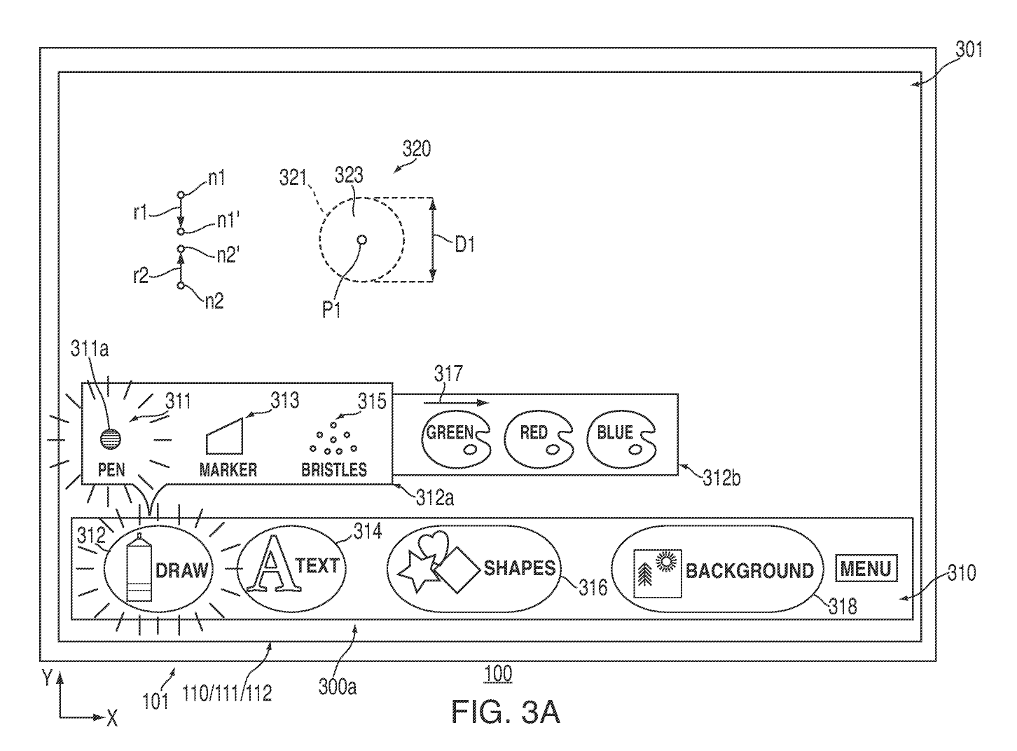

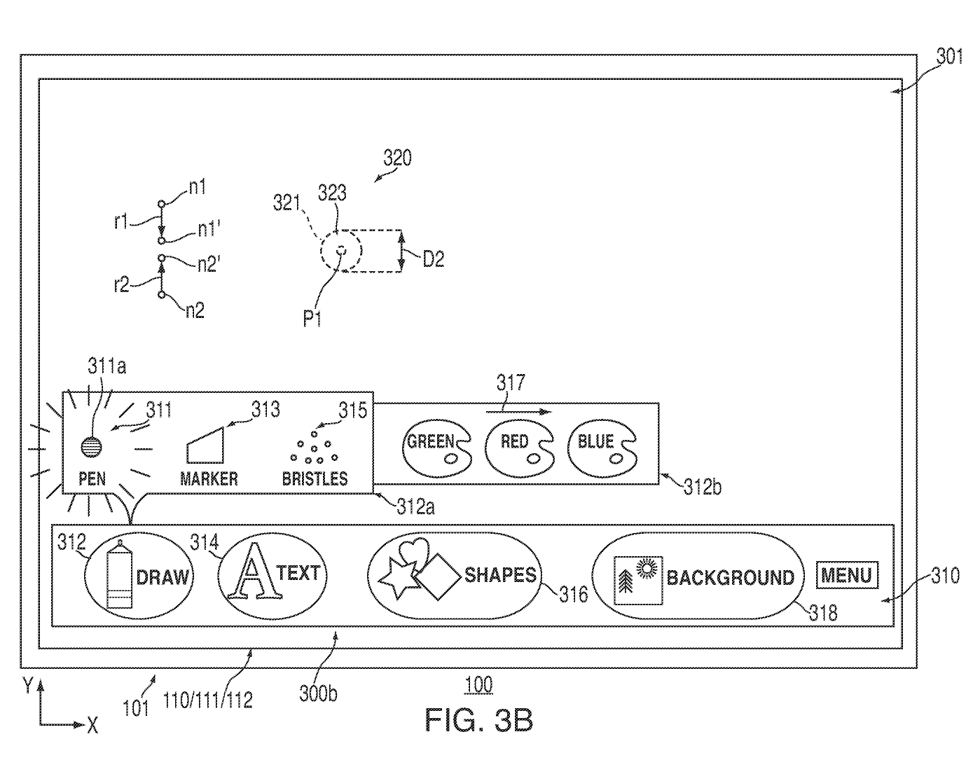

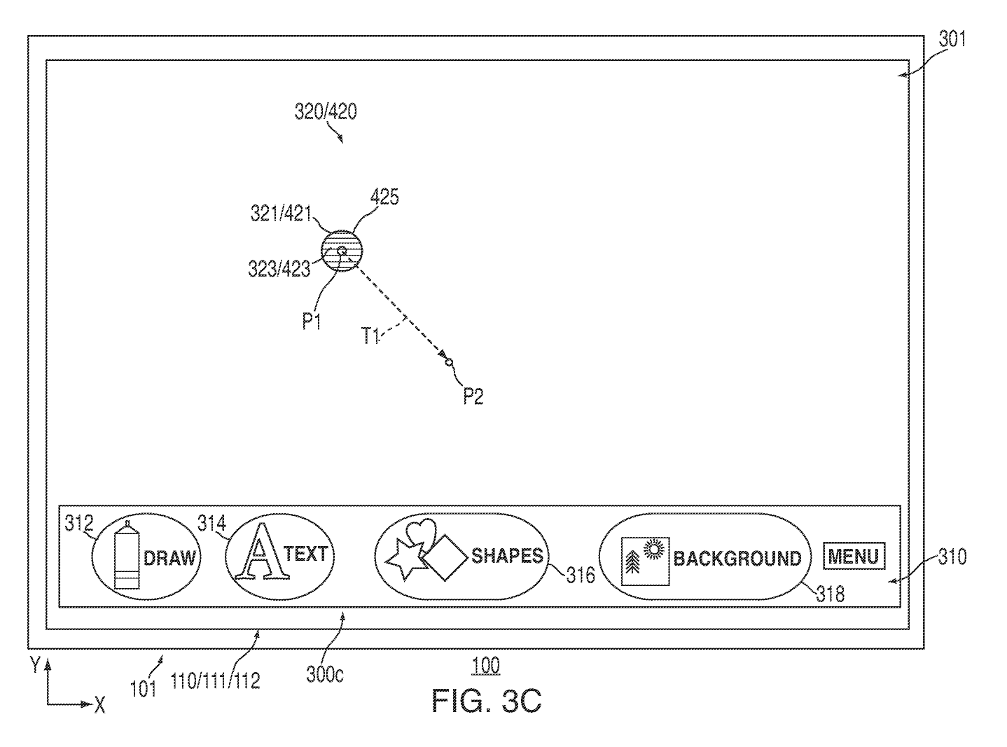

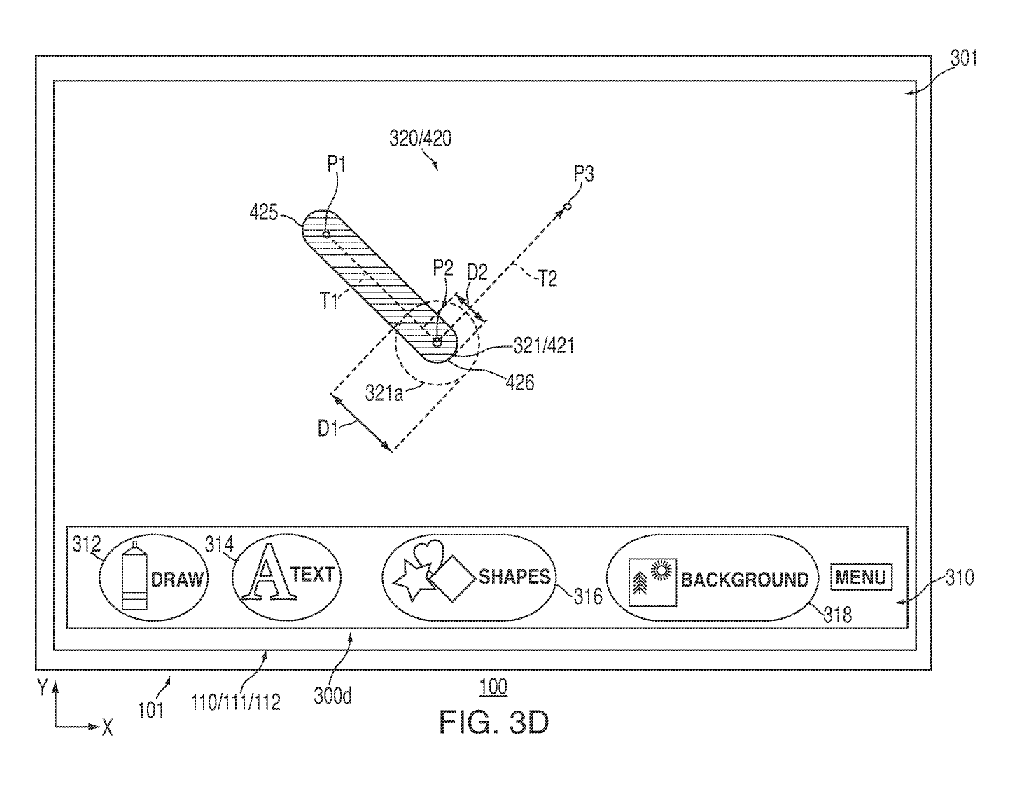

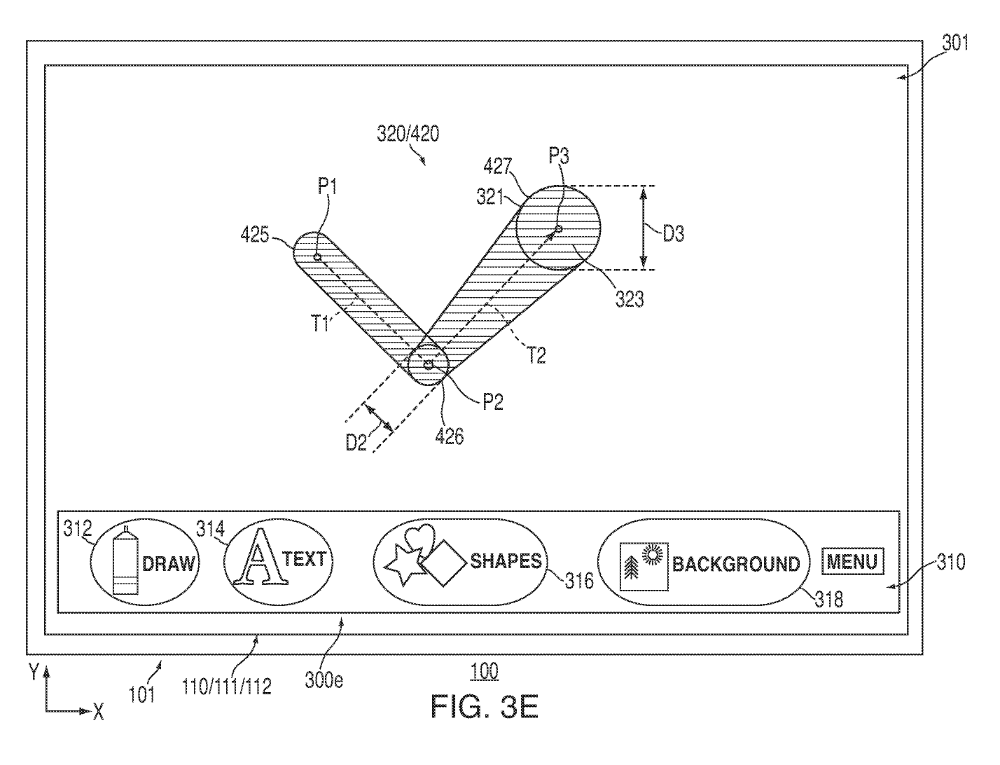

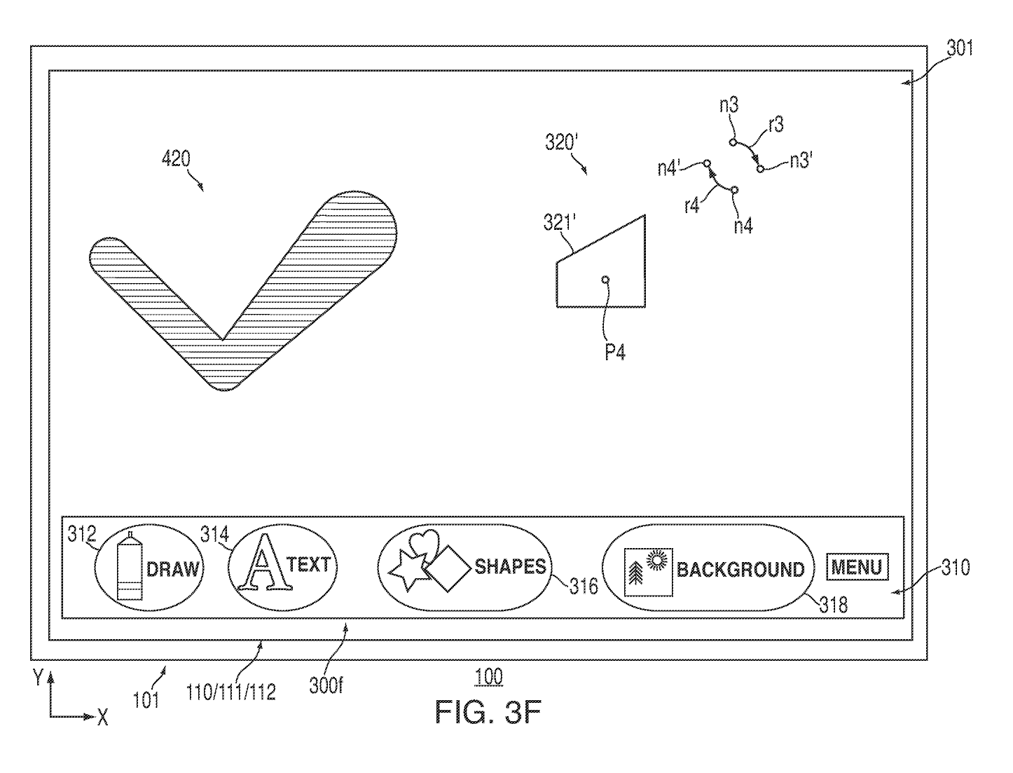

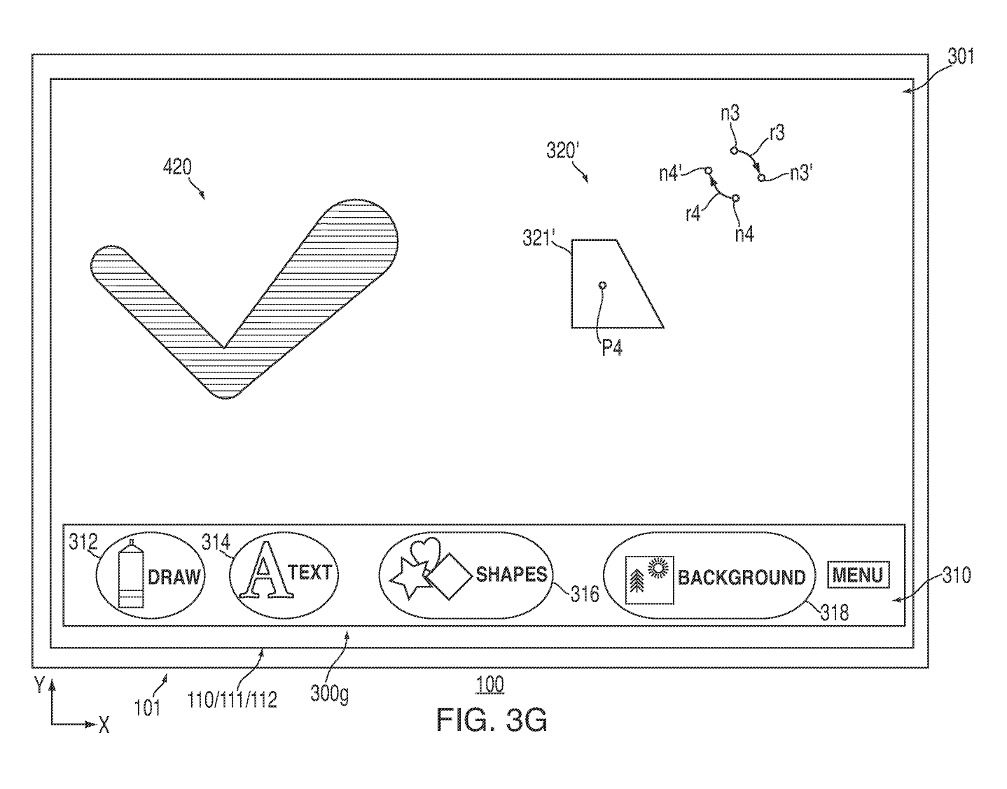

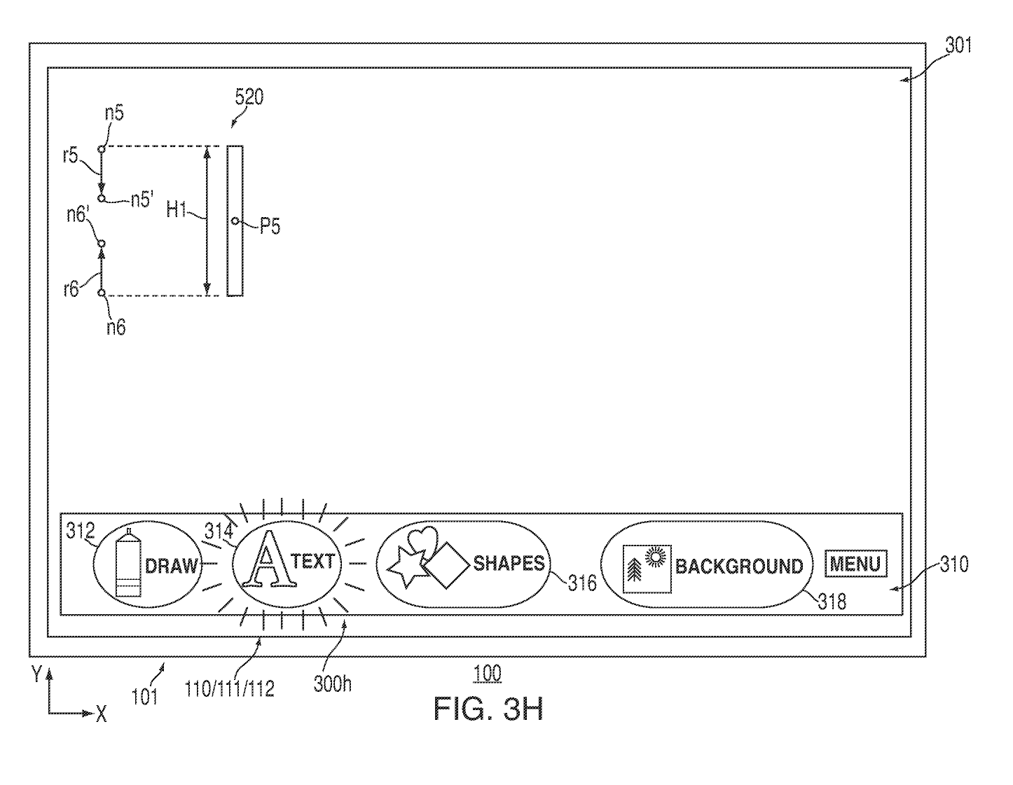

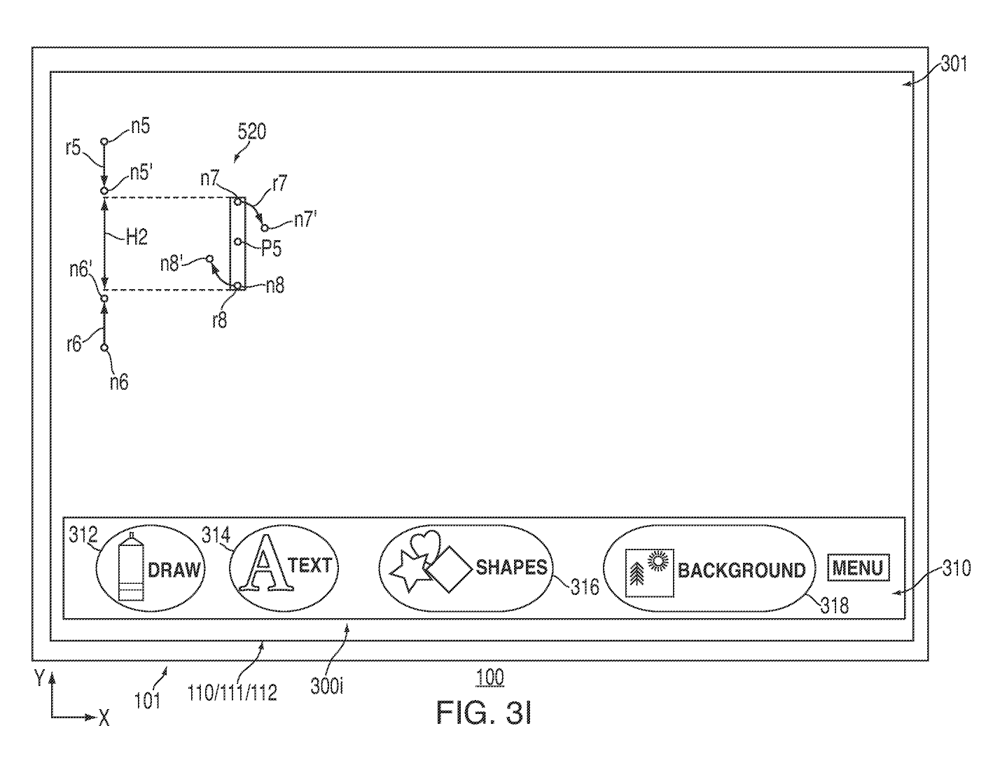

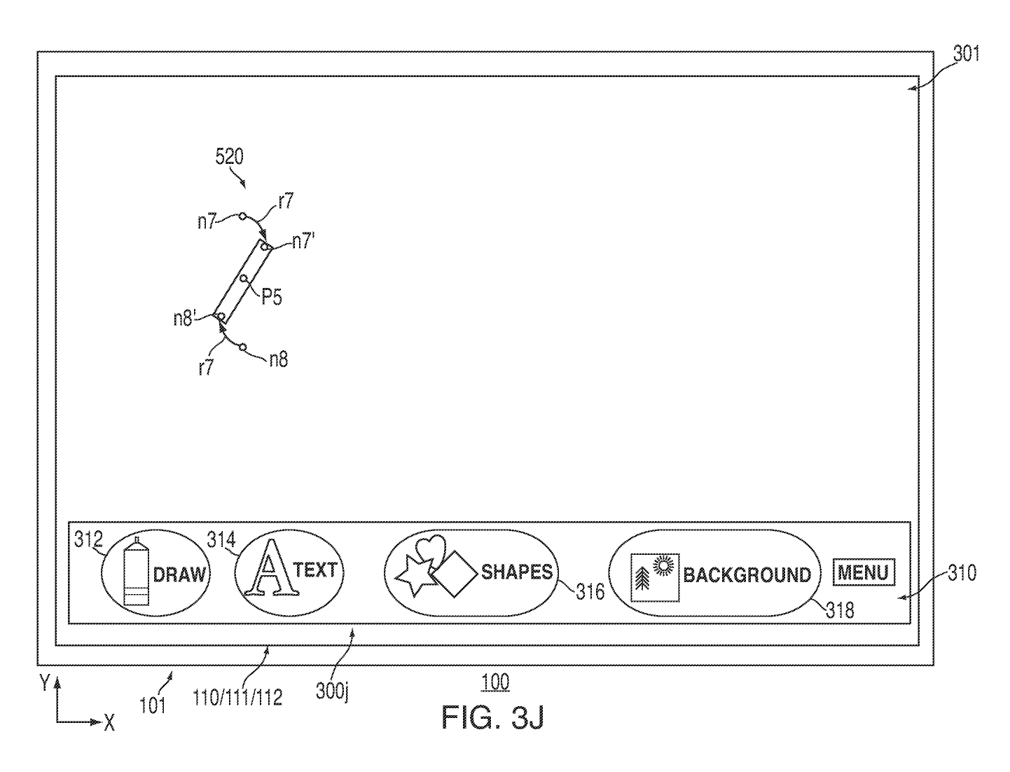

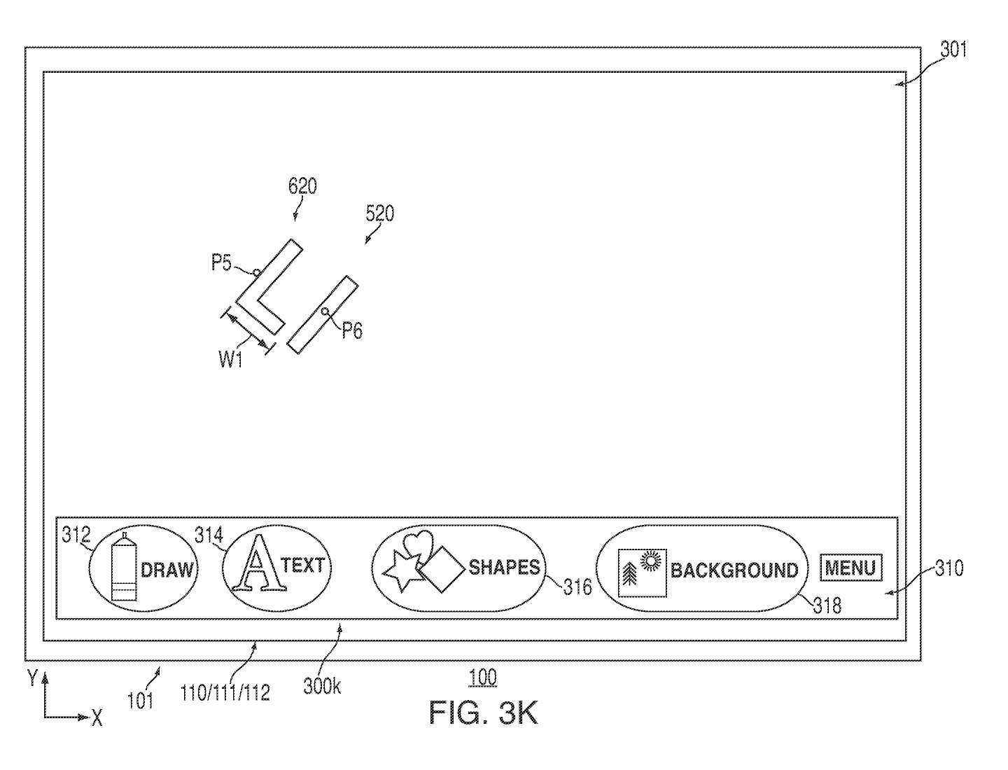

An illustrative example of how graphical display system 201 may generate and display graphical object content to a user may be described with reference to FIGS. 3A-3K.

FIGS. 3A-3K, for example, show electronic device 100 with housing 101 and display 112 presenting respective exemplary screens 300a-300K of visual information. As shown, display 112 may be combined with input component 110 to provide an I/O interface component 111, such as a touch screen. At least a portion of the visual information of each one of screens 300a-300k may be generated by graphical object generating module 210 and processed by graphical object processing module 220 of graphical display system 201. As shown, screens 300a-300k may present an interface for a virtual drawing space application of device 100, with which a user may create and manipulate graphical objects for making original works of art (e.g., a virtual drawing space application that may be similar to that of Photoshop™ or Illustrator™ by Adobe Systems Incorporated or Microsoft Paint™ by Microsoft Corporation). It is to be understood, however, that screens 300a-300k are merely exemplary, and display 112 may present any images representing any type of graphical objects and/or graphical object animation that may be generated and processed by graphical display system 201.

For example, as shown in FIGS. 3A-3k, a virtual drawing space application may provide a canvas area 301 on a portion of the screen in which various graphical objects may be presented. Canvas 301 may be a virtual drawing workspace portion of the screen in which pixel data may be created and manipulated for creating user works of art. The application may also provide on a portion of the screen at least one artist menu 310. Menu 310 may include one or more graphical input options that a user may choose from to access various tools and functionalities of the application that may then be utilized by the user to create various types of graphical objects in canvas area 301. Menu 310 may provide one or more toolbars, toolboxes, palettes, or any other suitable user interface menus that may be one or more layers or windows distinct from canvas 301.

As shown in FIGS. 3A-3K, for example, artist menu 310 may include a free-form drawing stroke or drawing tool input option 312, which a user may select for creating free-form drawing strokes in canvas area 301 (e.g., by repeatedly applying a stamp of a user-controlled virtual input drawing tool along a stroke trail in canvas area 301). Artist menu 310 may also include a text string input option 314, which a user may select for creating strings of characters in canvas area 301. Artist menu 310 may also include a drawing shape input option 316, which a user may select for creating various drawing shapes in canvas area 301. Moreover, artist menu 310 may also include a background image input option 318, which a user may select for importing video-based or photographic images into canvas area 301. It is to be understood, however, that options 312-318 of artist menu 310 are merely exemplary, and a virtual drawing space application may provide various other types of options that a user may work with for creating content in canvas area 301.

As shown by screen 300a of FIG. 3A, for example, a user may select drawing tool input option 312 of artist menu 310 for creating free-form drawing strokes in canvas area 301. When a user selects drawing tool input option 312, a sub-menu 312a of menu 310 may be displayed that can provide the user with one or more different types of pre-defined drawing stroke input tools that may be initially presented in canvas area 301. For example, drawing tool input sub-menu 312a may allow the user to select a drawing stroke input tool from a group of various pre-defined drawing stroke input tools or stamps, such as with an input tool sub-option 311 for presenting a “circular pen” drawing stroke input tool, an input tool sub-option 313 for presenting a “polygonal marker” drawing stroke input tool, and an input tool sub-option 315 for presenting a “triangular bristle” or brush drawing stroke input tool. It is to be understood that additional or alternative pre-defined drawing stroke input tools of various other pre-defined shapes, other pre-defined patterns, and other various pre-defined input tool properties may also be provided by drawing tool input sub-menu 312a of artist menu 310. Moreover, other drawing tool input menu options, such as a menu option to select the initial color or initial size or any other suitable stamp property of a stamp drawing tool may also be provided by drawing tool input menu option 312 of artist menu 310 (e.g., color sub-menu 312b of menu 310 of FIG. 3A). Any selections made by the user with respect to the options provided by drawing tool input option 312 may be received by graphical display system 201 for generating and displaying drawing stroke graphical object input tool content in canvas area 301. For example, selections made by the user with respect to the options provided by drawing tool input option 312 may be received by graphical object input tool defining module 212 of graphical object generating module 210 as graphical object input tool information 205.

When a user selects input tool sub-option 311 for initially presenting a pre-defined circular pen drawing stroke input tool, for example, the selection may be received by graphical object input tool defining module 212 as graphical object input tool information 205, and graphical object input tool defining module 212 may generate an appropriate circular stamp representation of such a tool as graphical object input tool content 213. This content 213 may be processed by graphical object processing module 220 to generate at least a portion of rendered graphical object input tool data 223 with pixel data that may represent at least a portion of that circular stamp input tool content 213, and that circular stamp representation pixel data may be presented on display 112 at a particular position in canvas area 301. For example, as also shown by screen 300a of FIG. 3A, in response to a user selecting input tool sub-option 311 for initially creating a pre-defined circular pen input tool, graphical display system 201 may generate and present circular-shaped graphical object stamp input tool 320 in canvas area 301 of display 112 at position P1 of canvas 301.

The initial position P1 of graphical object input tool 320 in canvas area 301 may be determined in any suitable way. For example, the user may select a portion of the canvas where graphical object input tool 320 should be initially positioned. Alternatively, the virtual drawing space application may automatically determine the initial position of new graphical object input tool 320, which may be done based on other content already existing in canvas area 301 or based on a pre-defined initial position for the selection made by the user in menu 310. Once stamp input tool 320 is presented on canvas 301, one or more stamp properties of stamp input tool 320 may be modified by a user before using stamp input tool 320 to generate a drawing stroke graphical object.

In some embodiments, as mentioned, graphical object input tool content 213 representative of a circular stamp input tool may only be at least partially rendered as rendered graphical object input tool data 223 by graphical display system 201. For example, although the stamp input tool content 213 may be generated as a complete representation of a circular stamp with a solid circular circumference shape stamp property and a dark color stamp property (e.g., as represented by symbol 311a of option 311 in menu 312a), only a portion of that stamp input tool content 213 may be rendered and presented as stamp input tool 320. As shown in FIG. 3A, for example, stamp input tool 320 may be presented with a broken line circular circumference 321 and a clear or transparent interior 323. By presenting stamp input tool 320 with an at least partially transparent interior 323, system 201 may present a stamp input tool on canvas 301 without obscuring certain other content that may already exist on canvas 301 (e.g., proximal to point P1). This may allow a user to more easily determine where it would like to position stamp 320 before using stamp 320 to create a drawing stroke graphical object.

Moreover, by presenting stamp input tool 320 with a broken line circumference or periphery 321, rather than its true solid periphery, system 201 may indicate to a user that at least one stamp property of stamp input tool 320 is currently configured to be modified (e.g., that input tool 320 is in a configurable state). It is to be understood that any other visual effect other than a broken line periphery, such as a blinking effect, may be utilized by system 201 when presenting a stamp input tool 320, such that a user may understand that one or more properties of the tool may currently be modified. In other embodiments, graphical object input tool content 213 representative of a circular stamp input tool may be fully rendered as rendered graphical object input tool data 223 by graphical display system 201 and presented as stamp input tool 320 on canvas 301 without any effects or other changes (e.g., with a solid circular circumference shape stamp property and a dark color stamp property, as represented by symbol 311a of option 311 in menu 312a), and yet stamp input tool 320 may still be in a configurable state. In some embodiments, when an input tool is initially presented on canvas 301, the input tool may be configured to be in its configurable state.

Therefore, regardless of whether or not stamp input tool 320 is rendered and presented on canvas 301 as a complete representation of its associated dark colored and solid periphery stamp input tool content 213, system 201 may be configured to allow a user to modify one or more input tool properties of stamp input tool 320 before using stamp input tool 320 to generate a drawing stroke graphical object. For example, a user may provide graphical object input tool defining module 212 with additional user input information as graphical object input tool information 205 for re-defining or otherwise changing one or more stamp properties of stamp input tool content 213, and thus potentially altering the appearance of stamp input tool 320 on canvas 301. In some embodiments, a user may simply interact with one or more menu options of menu 310 to provide input tool defining module 212 with new input tool information 205 for changing a stamp property of stamp input tool 320, such as by selecting a menu option that may re-define the color of the input tool (e.g., a menu option of color sub-menu 312b of menu 310 of FIG. 3A). This may be done using any suitable pointing input component 110, such as a mouse or touch component. For example, a user may double-click a mouse input component or double-tap a touch screen input component at a particular position on screen 300a of FIG. 3A that is presenting a selectable menu option of menu 310. It is to be understood, however, that any suitable pointing input component may be used by a user to point to or otherwise identify a particular menu option provided by menu 310 and any suitable input gesture of that pointing input component or another input component may be used to interact with that particular menu option in any particular way.

Alternatively, rather than interacting with a menu 310 that is distinct from canvas 301, a user may interact with canvas 301 directly in order to provide input tool defining module 212 with new input tool information 205 for changing a stamp property of stamp input tool 320. In some embodiments, input tool information 205 may be indicative of a user's interaction with system 201 that is independent of any menu options provided by menu 310 on an application screen (e.g., any menu option provided by menu 310 of screen 300a of FIG. 3A). For example, when system 201 provides input tool 320 in a configurable state, device 100 may be configured to allow a user to provide input tool information 205 to system 201 using any suitable gesture or gestures of any suitable input component or input components, such as a mouse or touch screen. A user may provide a pinch gesture on a touch screen, and system 201 may be configured to process such a gesture as input tool information 205 to reduce the size property of the input tool. For example, such a pinch gesture may be provided anywhere on touch screen 111, and not necessarily at a particular position on canvas 301 at or near tool 320 and not necessarily at a particular position with respect to menu 310.

Therefore, system 201 may be configured to treat a particular input gesture as a particular type of input tool information 205 for changing a particular input tool property in a particular way, regardless of the position of a pointer or other positional attribute of that input gesture. In other embodiments, system 201 may be configured to treat a particular input gesture as a particular type of input tool information 205 for changing a particular input tool property in a particular way when that gesture is associated with a particular position with respect to an input tool on canvas 301 (e.g., within a certain distance of input tool 320 on canvas 301). In any event, system 201 may be configured to treat a particular input gesture of a particular input component as a particular type of input tool information 205 for changing a particular input tool property in a particular way, and such an input gesture may be totally independent of the position of any menu option provided to a user on a user interface.

For example, as shown in FIG. 3A, a user may provide a pinch user input gesture on touch screen 111 by imparting a first touch event or gesture from position n1 to position n1′ in the direction of arrow r1, while also imparting a second touch event or gesture from position n2 to position n2′ in the direction of arrow r2, which may change the distance between the two touch events. Such a pinch gesture user input may be received as input tool information 205, and graphical object input tool defining module 212 may be configured to use this particular information 205 to reduce the size property of stamp input tool content 213, and thus the size of stamp input tool 320. For example, as shown by screen 300b of FIG. 3B, such a pinch gesture user input may result in system 201 presenting a modified stamp input tool 320 with a reduced size (e.g., the diameter D1 of initial tool 320 of FIG. 3A may be reduced to diameter D2 of modified tool 320 of FIG. 3B). As another example, a user may provide a pull user input gesture on touch screen 111 by imparting a first touch event from position n1′ to position n1 in a direction opposite that of arrow r1, while also imparting a second touch event from position n2′ to position n2 in a direction opposite that of arrow r2. Such a pull gesture user input may be received as input tool information 205, and graphical object input tool defining module 212 may be configured to use this particular information 205 to increase the size property of stamp input tool content 213, and thus the size of stamp input tool 320. In some embodiments, a pinch gesture including two touch events may be referred to as a multi-touch gesture. Similarly, in some embodiments, a pull gesture including two touch events may be referred to as a multi-touch gesture.

System 201 may be configured in any suitable way such that a particular input gesture of a particular input component may be received as a particular type of input tool information 205 for changing a particular input tool property in a particular way. For example, a user may define certain associations between certain gestures and certain properties. Alternatively, an application of device 100 may include pre-defined associations between particular input gestures and particular properties. Moreover, system 201 may be configured in any suitable way such that the associated position of a particular input gesture of a particular input component may or may not be within a particular distance of the position of a presented input tool. For example, system 201 may be configured to recognize the pinch input gesture described above as particular information 205 to reduce the size property of stamp input tool content 213 only if the distance between position n1 of the pinch gesture is within a certain threshold distance of position P1 of tool 320. In other embodiments, system 201 may be configured to recognize such a pinch input gesture as particular information 205 to reduce the size property of stamp input tool content 213 regardless of the relationship between position n1 of the pinch gesture and position P1 of tool 320. In any event, it is to be clear that system 201 may be configured to recognize a particular user input gesture as particular information 205 to change a particular property of input tool content 213 in a particular way regardless of the relationship between a position of the input gesture and a position of any menu option of a menu (e.g., menu 310).

It is also to be understood that any suitable gesture of any suitable input component may provide particular input tool information 205 for changing a particular input tool property in a particular way. For example, rather than modifying a size property of input tool 320 using pinch/pull input gestures on a touch screen input component, system 201 may be configured to additionally or alternatively use rotation input gestures on a scroll wheel input component to modify a size property of input tool 320. As another example, rather than modifying a size property of input tool 320, pinch/pull input gestures may be configured to modify the hardness of input tool 320 (e.g., the sharpness of the edges of an input tool).

Although a pinch/pull input gesture may have a particular magnitude associated therewith that may be used to determine the magnitude of a change of an input tool property (e.g., the magnitude of the decrease in size of an input tool may be proportional to the magnitude of the resulting distance between two touch events after being pinched towards one another), other input gestures that may not have an associated magnitude may also be used to provide particular input tool information 205 for changing a particular input tool property. For example, a single tap input gesture on a touch screen or a single click input gesture on a mouse input component may provide particular input tool information 205 for changing a color input tool property of input tool 320. Each single tap or click gesture may change the color input tool property from a current color to a new color. For example, if the color of input tool 320 is currently green at screen 300a of FIG. 3A, a single tap or click input gesture may provide particular input tool information 205 for changing the color input tool property of input tool 320 to red.

In some embodiments, the new color input tool property used in response to a single tap or click input gesture may be determined by a list of colors, and system 201 can be configured to cycle through the list of colors from a current color to a new color in response to a new single tap or click input gesture. Although such a single tap or click input gesture may be provided independently of the position of menu 310 presented to a user, menu 310 may be used to present to the user the list of colors that system 201 may cycle through in response to a new single tap or click input gesture. For example, as shown in FIG. 3A, sub-menu 312b may show such a list of colors (e.g., green, red, blue). Moreover, in some embodiments, menu 310 may provide an arrow 317 to indicate not only the current color input property of input tool 320 but also the direction in which system 201 cycles through the list of colors in response to a new color property changing input gesture (e.g., a new single tap or click input gesture). For example, while arrow 317 may indicate that tool 320 currently has a green color input property in screen 300a of FIG. 3A, in response to a single tap input gesture, arrow 317 may move within sub-menu 312 in the direction of arrow 317 to a new position, as shown by screen 300b of FIG. 3B, thereby indicating that tool 320 currently has a red color input property. Alternatively, sub-menu 312 may not be presented at all, either in FIG. 3A or in FIG. 3B, and the new input tool color property generated as a result of a new single tap or click input gesture may be communicated to a user by updating a visual characteristic of input tool 320. For example, in response to a new single tap or click input gesture, system 201 may be configured to change the color of periphery 321 of input tool 320 from green in screen 300a of FIG. 3A to red in screen 300b of FIG. 3B.

In some embodiments, rather than changing a color tool property, a single tap or click input gesture may be configured to change a pattern property of an input tool (e.g., from a pen, to a marker, to a bristle pattern tool). Alternatively, such a single tap or click input gesture, or any other suitable input gesture may be configured to change a shape property of an input tool (e.g., from a circle, to a polygon, to a triangle shape). It is to be understood that system 201 may be configured to change any input tool property in response to any particular input gesture or combination of input gestures generated by any type of input component or any combination of input components. Such input gestures may be independent of any visual menu or toolbar presented by an application on a screen. In some embodiments, such input gestures may also be independent of a position of an input tool presented by an application on a screen.

After input tool content 213 has been generated and at least a portion of that content has been processed and presented on canvas 301 as a stamp input tool 320, and after any of the input tool properties of content 213 have been changed (e.g., by particular input tool information 205 that may be generated by one or more particular user input gestures), a user may provide graphical object substance defining module 214 with particular user input information as drawing stroke substance information 207 for defining substance content 215 of a drawing stroke graphical object to be generated and presented on canvas 301 using stamp input tool 320. For example, the substance of a drawing stroke graphical object may include a stroke start event and a stroke stop event. A stroke start event may be defined by particular drawing stroke substance information 207 to indicate a particular initial position on canvas 301 where pixel data representative of stamp input tool content 213 is to be applied for generating at least an initial portion of a drawing stroke graphical object. A stroke stop event may be defined by particular drawing stroke substance information 207 to indicate a particular final position on canvas 301 where pixel data representative of stamp input tool content 213 is to be applied for generating a final portion of the drawing stroke graphical object.

In some embodiments, a user may simply interact with a particular position of canvas 301 to provide substance defining module 214 with new substance information 207 for defining a stroke start event and/or a stroke stop event. This may be done using any suitable input component 110, such as a mouse or touch screen. For example, a user may double-click or hold a mouse input component or double-tap or hold a touch screen input component at a particular position on canvas 301 to provide substance defining module 214 with new substance information 207 for defining a stroke start event. It is to be understood, however, that system 201 may be configured such that any suitable input component may be used by a user to point to or otherwise identify a particular position on canvas 301, and such that any suitable input gesture of that input component or another input component may be used to provide appropriate substance information 207 associated with the particular position for defining a stroke start event.

For example, a user may use any suitable stroke start gesture (e.g., by holding at least one finger on touch screen 111) at a stroke start position P1 of screen 300b of FIG. 3B to provide new substance information 207 for defining a stroke start event. Substance defining module 214 may receive this new substance information 207 as well as the current stamp input tool content 213 from input tool defining module 212, and substance defining module 214 may then generate new stroke start substance content 215 indicative of the stroke start event based on stroke start position P1 of information 207 and based on the pixel data representative of current stamp input tool content 213. This new stroke start substance content 215 may be rendered by rendering module 222 as rendered stroke start substance data 225. Then, as shown in screen 300c of FIG. 3C, for example, this rendered stroke start substance data 225 may be presented on canvas 301 at stroke start position P1 as at least an initial portion 425 of a drawing stroke graphical object 420. It is to be understood that a stroke start position need not be the initial position P1 of input tool 320. Instead, a user may indicate a different position on canvas 301 as the position at which an initial portion of a drawing stroke graphical object is to be presented.

In some embodiments, initial portion 425 of drawing stroke graphical object 420 may also be the final portion of drawing stroke graphical object 420. For example, after generating new stroke start substance content 215, substance defining module 214 may receive new substance information 207 indicative of a stroke stop event (e.g., after providing the substance information 207 for defining the stroke start event, a user may use any suitable stroke stop gesture at the same position P1 on canvas 301 to provide new substance information 207 for defining a stroke stop event). Substance defining module 214 may receive this new stroke stop substance information 207, and substance defining module 214 may then stop generating stroke start substance content 215. Therefore, rendering module 222 may stop rendering any new stroke stop substance data 225. Current rendered stamp input tool data 223 may continue to be presented on canvas 301 as input tool 320 once initial portion 425 of drawing stroke graphical object 420 is presented on canvas 301, as shown in FIG. 3C, for example, despite the fact that all visual characteristics of input tool 320 at point P1 may be indistinguishable from the visual characteristics of initial portion 425 of drawing stroke graphical object 420. In some embodiments, however, system 201 may alter a visual characteristic of input tool 320 to distinguish it from graphical object 420 (e.g., by altering the color of periphery 321 of tool 320).

In other embodiments, initial portion 425 of drawing stroke graphical object 420 may not be the final portion of drawing stroke graphical object 420. Instead, the substance of a drawing stroke graphical object may include not only a stroke start event and a stroke stop event, but also one or more stroke movement events between the start event and the stop event. The one or more stroke movement events may define a trail of positions on canvas 301 between the initial position associated with the stroke start event of graphical object 420 and the final position associated with the stroke stop event of graphical object 420. For example, after generating new stroke start substance content 215, but before receiving any substance information 207 indicative of a stroke stop event, substance defining module 214 may receive new substance information 207 indicative of at least one stroke movement event. A stroke movement event may be defined by particular drawing stroke substance information 207 that may indicate a particular new position on canvas 301 where pixel data representative of current stamp input tool content 213 is to be applied for generating an intermediate portion of a drawing stroke graphical object.

In some embodiments, a user may simply interact with a particular new position of canvas 301 to provide substance defining module 214 with new substance information 207 for defining a stroke movement event. This may be done using any suitable input component 110, such as a mouse or touch screen. For example, a user may drag a mouse input component or slide a finger along a touch screen input component from the initial position of the graphical object to a particular new position on canvas 301 to provide substance defining module 214 with new substance information 207 for defining a stroke movement event. It is to be understood, however, that system 201 may be configured such that any suitable input component may be used by a user to point to or otherwise identify a particular new position on canvas 301, and such that any suitable input gesture of that input component or another input component may be used to provide appropriate substance information 207 associated with the particular new position for defining a stroke movement event.

For example, a user may use any suitable stroke movement gesture (e.g., by dragging at least one finger on touch screen 111) along a trail T1 from stroke start position P1 of screen 300c of FIG. 3C to a particular new position P2 to provide new substance information 207 for defining a stroke movement event. Substance defining module 214 may receive this new substance information 207 as well as the current stamp input tool content 213 from input tool defining module 212, and substance defining module 214 may then generate new stroke movement substance content 215 indicative of the stroke movement event based on stroke movement trail T1 and position P2 of information 207 and based on the pixel data representative of current stamp input tool content 213. This new stroke movement substance content 215 may be rendered by rendering module 222 as rendered stroke movement substance data 225. Then, as shown in screen 300d of FIG. 3D, for example, this rendered stroke movement substance data 225 may be presented on canvas 301 at least at stroke movement position P2 of trail T1 as a new portion 426 of drawing stroke graphical object 420.

In some embodiments, substance defining module 214 may generate the new stroke movement substance content 215 indicative of the stroke movement event based not only on the pixel data representative of current stamp input tool content 213 and based not only on new stroke movement position P2, but also on one or more other positions along trail T1 between stroke start position P1 and new stroke movement position P2. Such stroke movement substance content 215 may be rendered by rendering module 222 as rendered stroke movement substance data 225, and this rendered stroke movement substance data 225 may be presented on canvas 301 not only at stroke movement position P2 but also at the one or more other positions along trail T1 between stroke start position P1 and new stroke movement position P2. The number of positions along trail T1 between stroke start position P1 and new stroke movement position P2 at which rendered stroke movement substance data 225 may be presented on canvas 301 may be based on a spacing input tool property of current stamp input tool content 213. Such a spacing input tool property may define the spacing between applications of the pixel data representative of stamp input tool content 213 along a trail defined by a stroke movement event (e.g., along trail T1 of drawing stroke graphical object 420). If the spacing input tool property is defined to be its smallest value, for example, the pixel data representative of stamp input tool content 213 may be applied at two positions on canvas 301 along trail T1 that are closest to one another, which may result in a smooth or continuous drawing stroke effect (e.g., as shown in FIG. 3D). Alternatively, if the spacing input tool property is increased, the application of the pixel data representative of stamp input tool content 213 may be spaced out along trail T1 for a more stuttered or dashed effect.

In some embodiments, new portion 426 of drawing stroke graphical object 420 may also be the final portion of drawing stroke graphical object 420. For example, after generating new stroke movement substance content 215, substance defining module 214 may receive new substance information 207 indicative of a stroke stop event (e.g., after providing the substance information 207 for defining the stroke movement event, a user may use any suitable stroke stop gesture at position P2 on canvas 301 to provide new substance information 207 for defining a stroke stop event). In such embodiments, substance defining module 214 may receive this new stroke stop substance information 207, and substance defining module 214 may then stop generating stroke movement substance content 215. Therefore, rendering module 222 may stop rendering any new stroke movement substance data 225.

In other embodiments, new portion 426 of drawing stroke graphical object 420 may not be the final portion of drawing stroke graphical object 420. Instead, after providing the substance information 207 for defining the stroke movement event defining trail T1 from stroke start position P1 to new stroke movement position P2, and before providing new substance information 207 for defining a stroke stop event, a user may provide new input tool information 205 for changing an input tool property of input tool content 213. If a user provides new input tool information 205 for changing an input tool property of input tool content 213 after a stroke start event but before a stroke stop event, that property change to current input tool content 213 may be applied by system 201 to substance content 215 and thus drawing stroke graphical object 420. However, if a user provides new input tool information 205 for changing an input tool property of input tool content 213 after a stroke stop event, but before a new stroke start event, that property change may not be applied to substance content 215 or drawing stroke graphical object 420 (e.g., at least not until a new stroke start event occurs, which may then apply the current properties of input tool content 213 to a new drawing stroke graphical object).

In some embodiments, however, after a new stroke start event but before a new stroke stop event, system 201 may be configured to temporarily suspend rendering of substance content 215 on canvas 301 while a property of input tool content 213 is being changed, such that the input tool property change is not automatically applied to the graphical object being generated. During such a suspension of rendering substance content 215, the current input tool content 213 may still be rendered and input tool 320 may still be presented on canvas 301, such that a change made to input tool content 213 may be visually displayed to a user. Such a changed input tool may serve as a visual preview, such that a user may decide whether or not to continue generating a graphical object according to the changed input tool. This may allow a user to see any input tool property changes on canvas 301 in the context of the properties of the graphical object portion that has already been generated and presented on canvas 301. System 201 may be configured to do such a temporary suspension of rendering substance content 215 either in response to a user preference or based on a setting on an application running on device 100.

As shown in FIG. 3D, for example, current rendered stamp input tool data 223 may continue to be presented on canvas 301 as input tool 320 once a new portion 426 of drawing stroke graphical object 420 is presented on canvas 301, despite the fact that some or all visual characteristics of input tool 320 at point P2 may be indistinguishable from the visual characteristics of new portion 426 of drawing stroke graphical object 420 at point P2. In some embodiments, however, system 201 may at least temporarily alter a visual characteristic of input tool 320 to distinguish it from graphical object 420. For example, system 201 may alter the color of periphery 321 of tool 320, which may visually distinguish tool 320 at point P2 from periphery 421 of new portion 426 of drawing stroke graphical object 420 at position P2. By visually distinguishing input tool 320 from graphical object 420, a user may be able to see on canvas 301 when an input tool property of input tool 320 is changed (e.g., when a size property of tool 320 is reduced).

Therefore, by visually changing how an input tool is represented on canvas 301 to indicate a change in an input tool property, system 201 may provide a user with a more efficient and intuitive user interface for generating graphical objects. System 201 may allow a user to change one or more properties of an input tool being used to create a graphical object “on-the-fly”, such that an input tool property change may be shown directly on canvas 301 at the current position of the tool. This may provide visual context for the change with respect to an already-generated portion of a graphical object (e.g., so a user may plainly see how a change to the input tool compares to graphical data generated by the tool prior to the change). For example, in response to particular input tool information 205 for increasing the size property of input tool content 213, system 201 may visually indicate this change on canvas 301 at the current position P2 of tool 320 (e.g., by visually increasing the size of input tool 320 from diameter D2 back to its original diameter D1, as shown in FIG. 3D by new perimeter 321a). Moreover, by allowing a user to generate input tool information 205 using input gestures independent of any menus, system 201 allows a user to focus directly on the graphical object being generated by the input tool, for example, without a user having to periodically move his or her attention away from the input tool on canvas 301 and towards a menu 310 for altering an input tool property. For example, system 201 may allow a user to generate input tool information 205 using an input gesture with a position that is directly associated with a position of an input tool on canvas 301.

In some embodiments, a user may provide new input tool information 205 for changing an input tool property of input tool content 213, while at the same time providing new substance information 207 indicative of at least one stroke movement event. Therefore, system 201 may not only apply pixel data representative of current stamp input tool content 213 along a new trail based on the new substance information 207, but system 201 may also re-define the pixel data representative of the current stamp input tool content 213 based on the new input tool information 205, such that a property of the drawing stroke graphical object may change along the new trail.

For example, a user may use any suitable stroke movement gesture (e.g., by dragging at least one finger on touch screen 111) from position P2 of screen 300d of FIG. 3D along a new trail T2 to a particular new position P3 to provide new substance information 207 for defining a new stroke movement event. Substance defining module 214 may receive this new substance information 207 as well as the current stamp input tool content 213 from input tool defining module 212, and substance defining module 214 may then generate new stroke movement substance content 215 indicative of the stroke movement event based on new stroke movement trail T2 and position P3 of information 207 and based on the pixel data representative of current stamp input tool content 213. This new stroke movement substance content 215 may be rendered by rendering module 222 as new rendered stroke movement substance data 225. Then, as shown in screen 300e of FIG. 3E, for example, this new rendered stroke movement substance data 225 may be presented on canvas 301 along trail T2, from stroke movement position P2 to stroke movement position P3, thereby providing a new portion 427 of drawing stroke graphical object 420 at new stroke movement position P3.

While providing this new substance information 207 for defining new trail T2, a user may also be providing new input tool information 205 for defining a new input tool property. For example, while providing this new substance information 207 for defining new trail T2, a user may also be providing a pull user input gesture on touch screen 111 that may be received as new input tool information 205 by input tool defining module 212. Based on this new input tool information 205, input tool defining module 212 may be configured to increase the size property of current stamp input tool content 213, and thus the size of drawing stroke graphical object 420 along new trail T2. For example, as also shown by screen 300e of FIG. 3E, such new input tool information 205 may result in system 201 increasing the size of stamp input tool 320, and thus drawing stroke graphical object 420, as drawing stroke graphical object 420 is presented along trail T2 from position P2 to position P3 (e.g., the diameter D2 of input tool 320 of FIG. 3D may be increased to diameter D3 of modified tool 320 of FIG. 3E).

It is to be understood that some input gesture types may be configured to change an input tool property discretely (e.g., a single tap input gesture may discretely change a color property from green to red), while other input gestures may be configured to change an input tool property more gradually or continuously (e.g., a pull user input gesture may gradually or continuously increase a size property as two touch events gradually or continuously pull farther away from one another). Therefore, as shown in FIG. 3E, for example, system 201 may be configured to allow a user to create a drawing stroke graphical object that continuously increases its diameter as it extends along trail T2 from position P2 to position P3.

It is to be understood that an input gesture configured to change an input tool property may be provided at the same time as another input gesture configured to define a trail. For example, a user may move a mouse input component to define a trail while also scrolling a scroll wheel of that same mouse to alter an input tool property of an input tool being moved along the trail. As another example, a user may drag a first finger along a touch component to define a trail while also tapping a second finger on that same touch component to alter an input tool property of an input tool being moved along the trail. As yet another example, a user may drag two fingers along a touch component to define a trail while pinching, pulling, or rotating the two fingers on that same touch component to alter an input tool property of an input tool being moved along the trail.

As another example of how user input information may alter an input tool property, a user may provide a rotate input gesture to alter an input tool property, such as an orientation property of an input tool. For example, when a user selects input tool sub-option 313 of FIG. 3A for initially presenting a pre-defined polygonal marker stroke input tool, the selection may be received by graphical object input tool defining module 212 as graphical object input tool information 205, and graphical object input tool defining module 212 may generate an appropriate polygonal-shaped stamp representation of such a tool as graphical object input tool content 213. This content 213 may be processed by graphical object processing module 220 to generate at least a portion of rendered graphical object input tool data 223 with pixel data that may represent at least a portion of that polygonal stamp input tool content 213, and that polygonal stamp representation pixel data may be presented on display 112 at a particular position in canvas area 301. For example, as shown by screen 300f of FIG. 3F, in response to a user selecting input tool sub-option 313 for initially creating a pre-defined polygonal input tool, graphical display system 201 may generate and present polygonal-shaped graphical object stamp input tool 320′ in canvas area 301 of display 112 at position P4 of canvas 301.

As shown in FIG. 3F, for example, stamp input tool 320′ may be presented with a polygonal perimeter 321′ that is asymmetrical. When system 201 provides polygonal input tool 320′ at position P4, device 100 may be configured to allow a user to provide input tool information 205 to system 201 using any suitable gesture or gestures of any suitable input component or input components to change an input tool property of tool 320′. For example, a user may provide a rotate gesture on a touch screen, and system 201 may be configured to process such a gesture as input tool information 205 to change the orientation property of input tool 320′. Such a rotate gesture may be provided anywhere on touch screen 111, and not necessarily at a particular position on canvas 301 at or near tool 320′.

For example, as shown in FIG. 3F, a user may provide a rotate user input gesture on touch screen 111 by imparting a first touch event from position n3 to position n3′ in the direction of arrow r3, while also imparting a second touch event from position n4 to position n4′ in the direction of arrow r4, which may change the angle between the two touch events. Such a rotate gesture user input may be received as input tool information 205, and graphical object input tool defining module 212 may be configured to use this particular information 205 to change the orientation property of stamp input tool content 213, and thus the orientation of stamp input tool 320′ on canvas 301. For example, as shown by screen 300g of FIG. 3G, such a rotate gesture user input may result in system 201 presenting a modified stamp input tool 320′ with a rotated orientation with respect to canvas 301 (e.g., the asymmetrical perimeter 321′ of tool 320′ may rotate 90° clockwise about point P4 from the initial orientation of FIG. 3F to the new orientation of FIG. 3G on canvas 301). By changing an orientation of an input tool, especially while also applying the input tool along a trail of a drawing stroke graphical object, the shape of a graphical object created by the tool on canvas 301 may also be changed in various ways. In some embodiments, a rotate gesture including two touch events may be referred to as a multi-touch gesture.

It is to be understood that various other input gestures, besides pinch/pull and rotate, may be used by system 201 to change an input tool property of an input tool presented on canvas 301. For example, the pressure of an input gesture may change an input tool property, such as a translucency property. As a user increases the pressure imparted by an input gesture, the translucency of an input tool may decrease, such that a darker drawing stroke may be created in response to a more intense user input gesture. For example, an increase in pressure imparted by a single touch event moving along a touch screen for defining a trail of a drawing stroke may also result in a decrease in the translucency of the input tool applying the drawing stroke as the input tool moves along the trail. Therefore, a single touch event may not only define a trail of a drawing stroke graphical object but the single touch event may also simultaneously change a property of the input tool, all while never disrupting the single touch event. That is a user's single finger may be dragged along a touch screen for both generating a drawing stroke trail and changing an input tool property while never having to lift the single finger. Therefore, in some embodiments, a user may change an input tool property while simultaneously moving the input tool along canvas 301, for example, all with a single input gesture that may only require a single user finger that may never have to be lifted off a touch screen. As another example, the number of simultaneous touch events may change an input tool property, such as a translucency property. For example, instead of dragging a single finger along a touch screen to define a trail of a stroke movement event, a user may drag two fingers along the touch screen to define at least a portion of a trail, such that a darker drawing stroke may be created along that portion of the trail.

As opposed to a drawing stroke graphical object, system 201 may be configured to generate a text string graphical object. For example, when graphical object generating module 210 is generating a text string graphical object, graphical object input tool defining module 212 may define a text string input tool to be a cursor or caret with a particular set of cursor properties. Graphical object input tool defining module 212 may receive various types of text string graphical object input tool information 205, such as a selection of one or more particular properties or characteristics, that may be used to define a cursor with a particular set of cursor properties. For example, a cursor input tool may be defined by any suitable cursor property or set of cursor properties including, but not limited to, font type (e.g., Arial or Courier), character size, style type (e.g., bold or italic), orientation, hardness, color, transparency, and the like. In some embodiments, a user of device 100 may select at least one of the cursor properties that may be used by graphical object input tool defining module 212 to define a cursor text string input tool for a text string graphical object. For example, a user may interact with one or more drawing applications running on device 100 via input component 110 to generate text string input tool information 205 for defining one or more of the cursor properties. Alternatively or additionally, in other embodiments, an application running on device 100 may be configured to automatically generate at least a portion of text string input tool information 205 for defining one or more of the cursor properties of a cursor text string input tool.

For example, a cursor may be defined by various cursor properties to have various shapes and sizes. A shape property may define a vertical line cursor and a size property may define a height of that vertical line. As another example, a shape property may define a horizontal line cursor and a size property may define a width of that horizontal line. As yet another example, a shape property may define a box-shaped cursor and a first size property may define a height of that box and a second size property may define a width of that box. A cursor input tool may be defined by any suitable shape and/or size that may indicate a size property of an alphanumeric character that may be entered at the cursor when the cursor is used for creating a text string graphical object. In other embodiments, the size or shape of a cursor input tool may not be representative of a size of a character to be entered at the cursor. However, in some embodiments, at least one visual property of a cursor input tool may be indicative of at least one respective property of a character that may be presented at the cursor. Graphical object substance defining module 214 may define the substance of a text string graphical object to be at least one alphanumeric character. Such a character may define a particular glyph to be presented on the display at the cursor (e.g., in accordance with at least one cursor property of the cursor).

Once text string input tool information 205 has been received, graphical object input tool defining module 212 may generate appropriate text string graphical object input tool content 213 based on the text string input tool information 205. For example, such text string input tool content 213 may be at least a partial representation of an appropriate cursor based on the selected cursor properties. For example, each possible combination of selectable cursor properties can define a different particular cursor, and each cursor can be generated using any suitable approach. In some embodiments, a cursor can be generated using an 8-bit bitmap that may be associated with one or more particular cursor properties. In another embodiment, a cursor can be generated using path data that may be associated with a cursor input tool of a particular cursor font type property but that can be resized based on the selected cursor size property. In some embodiments, graphical object input tool defining module 212 may include or may have access to a cursor repository or database that may have stored therein cursors for some or all drawing input tools of some or all possible cursor properties, and graphical object input tool defining module 212 may select particular cursors from the cursor database in response to received text string input tool information 205.

As shown by screen 300h of FIG. 3H, for example, a user may select text string input option 314 of artist menu 310 for creating text strings in canvas area 301. When a user selects text string input option 314, one or more sub-menus may be displayed that can provide the user with one or more different types of pre-defined text string input tools that may be initially presented in canvas area 301. For example, such sub-menus may be similar to sub menus 312a and 312b of FIG. 3A, but may provide various text related property options for a text string input tool, such as font type, text size, text color, and the like. Alternatively, a default text string input tool having pre-defined properties may be presented on canvas 301 when a user selects text string input option 314. For example, when a user selects text string input option 314 for initially presenting a pre-defined text string input tool, the selection may be received by graphical object input tool defining module 212 as graphical object input tool information 205, and graphical object input tool defining module 212 may generate an appropriate cursor representation of such a tool as graphical object input tool content 213. This content 213 may be processed by graphical object processing module 220 to generate at least a portion of rendered graphical object input tool data 223 with pixel data that may represent at least a portion of that cursor input tool content 213, and that cursor representation pixel data may be presented on display 112 at a particular position in canvas area 301. For example, as also shown by screen 300h of FIG. 3H, in response to a user selecting text string input option 314, graphical display system 201 may generate and present text string graphical object cursor input tool 520 in canvas area 301 of display 112 at position P5 of canvas 301.

System 201 may be configured to allow a user to modify one or more input tool properties of cursor input tool 520 before using cursor input tool 520 to generate a text string graphical object. For example, a user may provide graphical object input tool defining module 212 with additional user input information as graphical object input tool information 205 for re-defining or otherwise changing one or more cursor properties of cursor input tool content 213, and thus potentially altering the appearance of cursor input tool 520 on canvas 301. In some embodiments, a user may simply interact with one or more menu options of menu 310 to provide input tool defining module 212 with new input tool information 205 for changing a cursor property of cursor input tool 520, such as by selecting a menu option that may re-define the color of the input tool (e.g., a menu option similar to color sub-menu 312b of menu 310 of FIG. 3A). Alternatively, rather than interacting with a menu 310 that is distinct from canvas 301, a user may interact with canvas 301 directly in order to provide input tool defining module 212 with new input tool information 205 for changing a cursor property of stamp input tool 520.

For example, a user may provide a pinch gesture on a touch screen, and system 201 may be configured to process such a gesture as input tool information 205 to reduce the size property of the input tool. Such a pinch gesture may be provided anywhere on touch screen 111, and not necessarily at a particular position on canvas 301 at or near tool 520 and not necessarily at a particular position with respect to menu 310. Therefore, system 201 may be configured to treat a particular input gesture as a particular type of input tool information 205 for changing a particular cursor input tool property of cursor input tool 520 in a particular way, regardless of the position of a pointer or other positional attribute of that input gesture. In other embodiments, system 201 may be configured to treat a particular input gesture as a particular type of input tool information 205 for changing a particular input tool property of cursor input tool 520 in a particular way when that gesture is associated with a particular position with respect to an input tool on canvas 301 (e.g., within a certain distance of point P5 of input tool 520 on canvas 301). In any event, system 201 may be configured to treat a particular input gesture of a particular input component as a particular type of input tool information 205 for changing a particular input tool property of cursor input tool 520 in a particular way, and such an input gesture may be totally independent of the position of any menu option provided to a user on a user interface.

For example, as shown in FIG. 3H, a user may provide a pinch user input gesture on touch screen 111 by imparting a first touch event from position n5 in the direction of arrow r5 to position n5′ while also imparting a second touch event from position n6 in the direction of arrow r6 to position n6′. Such a pinch gesture user input may be received as input tool information 205, and graphical object input tool defining module 212 may be configured to use this particular information 205 to reduce the size property of cursor input tool content 213, and thus the size of cursor input tool 520. For example, as shown by screen 300i of FIG. 3I, such a pinch gesture user input may result in system 201 presenting a modified cursor input tool 520 with a reduced size (e.g., the height H1 of initial cursor tool 520 of FIG. 3H may be reduced to height H2 of modified cursor tool 520 of FIG. 3I). By changing the size of cursor input tool 520, the size of any text string character to be generated and presented on canvas 301 as a text string graphical object using cursor input tool 520 may be defined by the changed size of cursor input tool 520.

In some embodiments, a magnitude of a user input gesture may be configured to change an input tool property by that same magnitude. This may provide the user with a greater sense of control over the tool and thus the graphical object the user is creating. For example, as shown in FIG. 3H, the distance between position n5 of the first touch event and position n6 of the second touch event at the start of the pinch gesture may correspond to the height H1 of cursor input tool 520 at the start of the pinch gesture, and likewise, as shown in FIG. 3I, the distance between position n5′ of the first touch event and position n6′ of the second touch event at the end of the pinch gesture may correspond to the height H2 of cursor input tool 520 at the end of the pinch gesture.

In addition to changing a size property of cursor input tool 520, a user may also change an orientation property of cursor input tool 520 to dictate the angle at which text string characters may be presented on canvas 301. For example, as shown in FIG. 3I, a user may provide a rotate user input gesture on touch screen 111 by imparting a first touch event from position n7 in the direction of arrow r7 to position n7′ while also imparting a second touch event from position n8 in the direction of arrow r8 to position n8′. Such a rotate gesture user input may be received as input tool information 205, and graphical object input tool defining module 212 may be configured to use this particular information 205 to change the orientation property of cursor input tool content 213, and thus the orientation of cursor input tool 520 on canvas 301. For example, as shown by screen 300j of FIG. 3J, such a rotate gesture user input may result in system 201 presenting a modified cursor input tool 520 with a rotated orientation (e.g., cursor input tool 520 may be rotated 45° clockwise about point P5 from the initial orientation of FIG. 3I to the new orientation of FIG. 3J).

In some embodiments, user input gestures configured to change an input tool property may interact directly with portions of the presented visual representation of the tool. This may provide the user with a greater sense of control over the tool and thus the graphical object the user is creating. For example, as shown in FIG. 3I, position n7 of the first touch event and position n8 of the second touch event at the start of the rotate gesture may correspond to positions at which respective portions of cursor input tool 520 are presented on canvas 301 (e.g., the top and bottom portions of tool 520, respectively), and likewise, as shown in FIG. 3J, position n7′ of the first touch event and position n8′ of the second touch event at the end of the rotate gesture may correspond to positions at which those same respective portions of cursor input tool 520 are presented on canvas 301. Therefore, in some embodiments, a position associated with an input gesture configured to change an input tool property may be the same position as a portion of the displayed input tool.

It is to be understood that various other input gestures, besides pinch/pull and rotate, may be used by system 201 to change a cursor input tool property of a cursor input tool presented on canvas 301, and that various other cursor input tool properties may be changed besides a size property and an orientation property. For example, a color property of cursor input tool 520 may be changed to dictate the color of text string characters generated using tool 520. As another example, a font property of cursor input tool 520 may be changed to dictate the font of text string characters generated using tool 520.

After input tool content 213 has been generated and at least a portion of that content has been processed and presented on canvas 301 as a cursor input tool 520, and after any of the input tool properties of content 213 have been changed (e.g., by particular input tool information 205 that may be generated by one or more particular user input gestures), a user may provide graphical object substance defining module 214 with particular user input information as text string substance information 207 for defining substance content 215 of a text string graphical object to be generated and presented on canvas 301. For example, the substance of a text string graphical object may include the selection of at least one alphanumeric character. Therefore, a user may provide text string substance information 207 indicative of one or more alphanumeric characters, for example, by typing on a keyboard input component 110. It is to be understood, however, that system 201 may be configured such that any suitable input component may be used by a user to indicate a particular character for a text string graphical object (e.g., a virtual keyboard may be presented adjacent canvas 301 on touch screen 111).

For example, a user may press the letter “L” key of a keyboard input component to generate a particular new character substance information 207. Substance defining module 214 may receive this new character substance information 207 as well as the current cursor input tool content 213 from input tool defining module 212, and substance defining module 214 may then generate new character substance content 215 based on the new character defined by information 207 and based on the cursor properties of current cursor input tool content 213 (e.g., as a particular glyph). This new character substance content 215 may be rendered by rendering module 222 as rendered character substance data 225. Then, as shown in screen 300k of FIG. 3K, for example, this rendered character substance data 225 may be presented on canvas 301 as at least an initial character 625 of a text string graphical object 620.

When generating and presenting a new character portion of a text string graphical object 620, system 201 may be configured to update the position of cursor input tool 520 from an initial position to a new position. For example, when presenting new character 625, the position of cursor input tool 520 may be updated from initial position P5 of FIG. 3J to a new position P6 of FIG. 3K. This new cursor position P6 may be offset from previous cursor position P5 based on one or more cursor properties of current cursor input tool content 213 defined by particular input tool information 205 and/or based on one or more substance properties of new character substance content 215 defined by new character substance information 207.

For example, a particular cursor property of current cursor input tool content 213 defined by particular input tool information 205 may be an alignment property that may dictate the direction or alignment of characters presented with respect to the cursor (e.g., to the left or right of the cursor). With respect to cursor 520 and text string 620, an alignment property and/or a language property of cursor 520 may dictate that a new character be presented to the right of the initial position of the cursor and that the cursor advance to the right of that new character before presenting a new character. As shown in FIG. 3K, for example, at least based on a particular cursor property of current cursor input tool content 213, new character 625 may be presented on canvas 301 just to the right of the initial position P5 of cursor tool 520, and the new position of cursor tool 520 may be positioned to the right of new character 625.

As another example, a particular substance property of a new character substance content 215 defined by new character substance information 207 may be indicative of a particular geometry of the particular glyph of that character. For example, regardless of the size property or font property or various other properties of cursor input tool 520, the width of a new character 625 may be at least partially based on the particular character it is representing (e.g., the particular character defined by new character substance information 207). For example, a width W1 of new character 625 may be greater for a character “L” than it may be for a character “,”. Therefore, the amount by which new cursor position P6 may be offset from previous cursor position P5 may be at least partially based on a substance property of new character substance content 215 defined by new character substance information 207. For example, as shown in FIG. 3K, at least based on a particular substance property of new character substance content 215, the new position P6 of cursor 520 on canvas 301 may be offset from previous position P5 at least by width W1 of new character 625.

After new character 625 has been presented, one or more cursor properties of cursor 520 may be changed based on new input tool information 205. In some embodiments, system 201 may be configured to update previously presented character 625 based on a changed cursor property. Alternatively, system 201 may be configured to present only future characters of text string graphical object 620 based on a changed cursor property. In some embodiments, a user preference option may dictate whether or not system 201 updates a previously presented character 625 based on a changed cursor property.

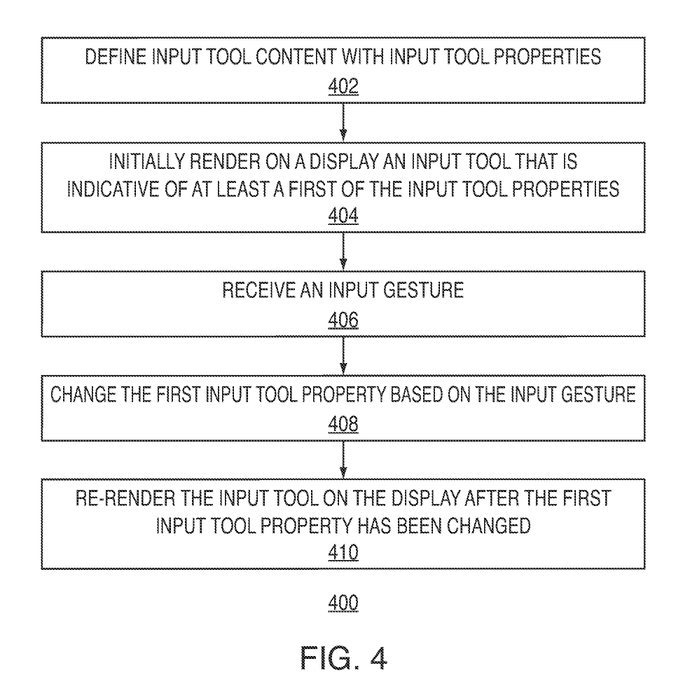

FIG. 4 is a flowchart of an illustrative process 400 for generating graphical object data. Process 400 may begin at step 402 by defining input tool content with various input tool properties. For example, graphical object input tool defining module 212 of graphical object generating module 210 may define input tool content 213 with various particular input tool properties (e.g., a size input tool property, an orientation input tool property, etc.) based on various particular types of input tool information 205, which may be provided by various particular input gestures. Next, at step 404, process 400 may initially render on a display an input tool that may be indicative of at least a first input tool property of the input tool properties that may define the input tool content. For example, rendering module 222 of graphical object processing module 220 may render at least a portion of input tool content 213 as rendered input tool data 223 for presentation on display 112 as an input tool. The presented input tool may be indicative of at least a first input tool property of the input tool properties defining input tool content 213.

At step 406, an input gesture may be received and, at step 408, the first input tool property may be changed based on the received input gesture. Then, at step 410, after the first input tool property has been changed, the input tool may be re-rendered on the display. For example, new graphical input tool information 205 may be provided by an input gesture, and that new input tool information 205 may be received by input tool defining module 212 for changing the first input tool property of input tool content 213. Rendering module 222 may then re-render at least a portion of input tool content 213 after the first input tool property has been changed, as re-rendered input tool data 223, for presentation on display 112 as a re-rendered input tool.

In some embodiments, the input gesture received at step 406 may be a multi-touch input gesture. For example, the input gesture may be a multi-touch rotate input gesture that may change an orientation input tool property of the input tool content. As another example, the input gesture may be a multi-touch pinch or pull input gesture that may change a size input tool property of the input tool content.

In some embodiments, the input gesture received at step 406 may be independent of any menu provided on the display. For example, rather than interacting with a menu 310 that is distinct from a workspace canvas 301, a user input gesture may interact directly with canvas 301 in order to provide input tool defining module 212 with new input tool information 205 for changing an input tool property of an input tool. By allowing a user to generate input tool information 205 using an input gesture independent of any menu, system 201 may allow a user to focus directly on the graphical object being generated by the input tool, for example, without a user having to periodically move his or her attention away from the input tool on canvas 301 and towards a menu 310 for altering an input tool property.

In some embodiments, the input gesture received at step 406 may be indicative of at least one position on the display where the input tool is initially rendered. For example, system 201 may allow a user to generate input tool information 205 using an input gesture with a position that is directly associated with a position of an input tool on canvas 301. This may provide the user with a greater sense of control over the input tool and its various input tool properties.

In some embodiments, process 400 may also include receiving substance information and rendering a graphical object on the display based on the substance information and the input tool content. For example, graphical object substance defining module 214 may receive substance information 207 as well as current input tool content 213 for defining substance content 215, which may then be rendered by rendering module 222 as rendered substance data 225 on display 112 as a graphical object. Substance information 207 may be information defining a trail along which stamp input content 213 may be applied for generating a drawing stroke graphical object. Alternatively, substance information 207 may be information defining a character that may be rendered at the position of the input tool according to one or more input tool properties of its input tool content 213.

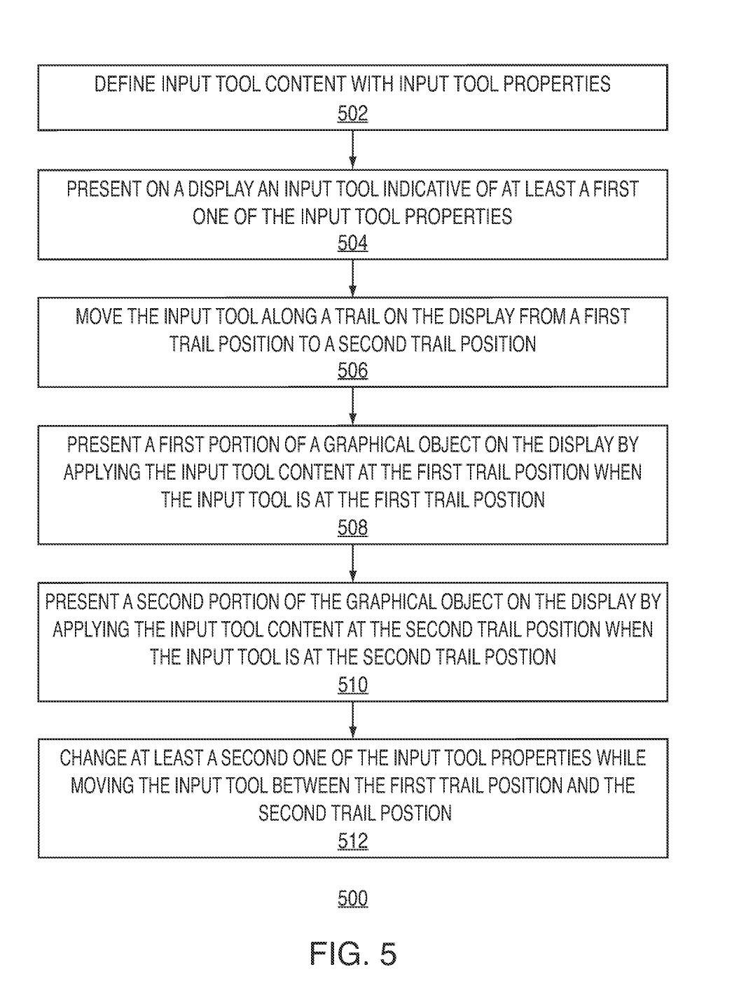

FIG. 5 is a flowchart of an illustrative process 500 for generating a graphical object. Process 500 may begin at step 502 by defining input tool content with multiple of input tool properties. For example, graphical object input tool defining module 212 of graphical object generating module 210 may define input tool content 213 with multiple particular input tool properties (e.g., a size input tool property, an orientation input tool property, etc.) based on various particular types of input tool information 205. Next, at step 504, process 500 may present on a display an input tool indicative of at least a first input tool property of the multiple input tool properties. For example, rendering module 222 of graphical object processing module 220 may render at least a portion of input tool content 213 as rendered input tool data 223 for presentation on display 112 as an input tool. The presented input tool may be indicative of at least a first input tool property of the input tool properties defining input tool content 213.

Next, at step 506, the input tool may be moved along a trail on the display from a first trail position to a second trail position. At step 508, the input tool content may be applied at the first trail position on the display when the input tool is at the first trail position such that a first portion of a graphical object may be presented on the display. Similarly, at step 510, the input tool content may be applied at the second trail position on the display when the input tool is at the second trail position such that a second portion of the graphical object may be presented on the display. For example, graphical object substance defining module 214 may receive substance information 207 as well as current input tool content 213 for defining substance content 215, which may then be rendered by rendering module 222 as rendered substance data 225 on display 112 as a graphical object. Substance information 207 may be information defining a trail along which stamp input content 213 may be applied for generating a drawing stroke graphical object.

At step 512, at least a second input tool property of the input tool content may be changed while the input tool is being moved between the first trail position and the second trail position. For example, a user may provide new input tool information 205 for changing an input tool property of input tool content 213, while at the same time providing new substance information 207 indicative of at least one stroke movement event for defining a trail. Therefore, not only may system 201 apply pixel data representative of current stamp input tool content 213 along a new trail based on new substance information 207, but system 201 may also re-define the pixel data representative of the current stamp input tool content 213 based on the new input tool information 205, such that a property of the drawing stroke graphical object may change as the input tool is moved along the new trail.

In some embodiments, an input gesture configured to change an input tool property may be provided at the same time as another input gesture configured to define a trail. For example, a user may move a mouse input component to define a trail for moving an input tool while also scrolling a scroll wheel of that same mouse to alter an input tool property of the input tool being moved along the trail. As another example, a user may drag a first finger along a touch component to define a trail while also tapping a second finger on that same touch component to alter an input tool property of the input tool being moved along the trail. As yet another example, a user may drag two fingers along a touch component to define a trail while pinching, pulling, or rotating the two fingers on that same touch component to alter an input tool property of the input tool being moved along the trail.

It is to be understood that the steps shown in each one of processes 400 and 500 of FIGS. 4 and 5, respectively, are merely illustrative and that existing steps may be modified or omitted, additional steps may be added, and the order of certain steps may be altered.

Moreover, the processes described with respect to FIGS. 4 and 5, as well as any other aspects of the invention, may each be implemented by software, but may also be implemented in hardware, firmware, or any combination of software, hardware, and firmware. They each may also be embodied as computer-readable code recorded on a computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices (e.g., memory 104 of FIG. 1). The computer-readable medium can also be distributed over network-coupled computer systems so that the computer readable code is stored and executed in a distributed fashion. For example, the computer-readable medium may be communicated from one electronic device to another electronic device using any suitable communications protocol (e.g., the computer-readable medium may be communicated to electronic device 100 via communications circuitry 106). The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that each module of graphical display system 201 may be provided as a software construct, firmware construct, one or more hardware components, or a combination thereof. For example, graphical display system 201 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of graphical display system 201 are merely illustrative, and that the number, configuration, functionality, and interconnection of existing modules may be modified or omitted, additional modules may be added, and the interconnection of certain modules may be altered.

At least a portion of one or more of the modules of system 201 may be stored in or otherwise accessible to device 100 in any suitable manner (e.g., in memory 104 of device 100 or via communications circuitry 106 of device 100). Each module of system 201 may be implemented using any suitable technologies (e.g., as one or more integrated circuit devices), and different modules may or may not be identical in structure, capabilities, and operation. Any or all of the modules or other components of system 201 may be mounted on an expansion card, mounted directly on a system motherboard, or integrated into a system chipset component (e.g., into a “north bridge” chip). System 201 may include any amount of dedicated graphics memory, may include no dedicated graphics memory and may rely on device memory 104 of device 100, or may use any combination thereof.

Graphical display system 201 may be a dedicated system implemented using one or more expansion cards adapted for various bus standards. For example, all of the modules may be mounted on different interconnected expansion cards or all of the modules may be mounted on one expansion card. The modules of system 201 may interface with a motherboard or processor 102 of device 100 through an expansion slot (e.g., a peripheral component interconnect (“PCI”) slot or a PCI express slot). Alternatively, system 201 need not be removable but may include one or more dedicated modules that may include memory (e.g., RAM) dedicated to the utilization of the module. In other embodiments, system 201 may be a graphics system integrated into device 100. For example, a module of system 201 may utilize a portion of device memory 104 of device 100. One or more of the modules of graphical display system 201 may include its own processing circuitry and/or memory. Alternatively each module of graphical display system 201 may share processing circuitry and/or memory with any other module of graphical display system 201 and/or processor 102 and/or memory 104 of device 100.

As mentioned, an input component 110 of device 100 may include a touch input component that can receive touch input for interacting with other components of device 100 via wired or wireless bus 114. Such a touch input component 110 may be used to provide user input to device 100 in lieu of or in combination with other input components, such as a keyboard, mouse, and the like. One or more touch input components may be used for providing user input to device 100.

A touch input component 110 may include a touch sensitive panel, which may be wholly or partially transparent, semitransparent, non-transparent, opaque, or any combination thereof. A touch input component 110 may be embodied as a touch screen, touch pad, a touch screen functioning as a touch pad (e.g., a touch screen replacing the touchpad of a laptop), a touch screen or touch pad combined or incorporated with any other input device (e.g., a touch screen or touch pad disposed on a keyboard), or any multi-dimensional object having a touch sensitive surface for receiving touch input. In some embodiments, the terms touch screen and touch pad may be used interchangeably.

In some embodiments, a touch input component 110 embodied as a touch screen may include a transparent and/or semitransparent touch sensitive panel partially or wholly positioned over at least a portion of a display (e.g., display 112). In other embodiments, a touch input component 110 may be embodied as an integrated touch screen where touch sensitive components/devices are integral with display components/devices. In still other embodiments, a touch input component 110 may be used as a supplemental or additional display screen for displaying supplemental or the same graphical data as a primary display and to receive touch input.

A touch input component 110 may be configured to detect the location of one or more touches or near touches based on capacitive, resistive, optical, acoustic, inductive, mechanical, chemical measurements, or any phenomena that can be measured with respect to the occurrences of the one or more touches or near touches in proximity to input component 110. Software, hardware, firmware, or any combination thereof may be used to process the measurements of the detected touches to identify and track one or more gestures. A gesture may correspond to stationary or non-stationary, single or multiple, touches or near touches on a touch input component 110. A gesture may be performed by moving one or more fingers or other objects in a particular manner on touch input component 110, such as by tapping, pressing, rocking, scrubbing, rotating, twisting, changing orientation, pressing with varying pressure, and the like at essentially the same time, contiguously, or consecutively. A gesture may be characterized by, but is not limited to, a pinching, sliding, swiping, rotating, flexing, dragging, or tapping motion between or with any other finger or fingers. A single gesture may be performed with one or more hands, by one or more users, or any combination thereof.

As mentioned, electronic device 100 may drive a display (e.g., display 112) with graphical data to display a graphical user interface (“GUI”). The GUI may be configured to receive touch input via a touch input component 110. Embodied as a touch screen (e.g., with display 112 as I/O component 111), touch I/O component 111 may display the GUI. Alternatively, the GUI may be displayed on a display (e.g., display 112) separate from touch input component 110. The GUI may include graphical elements displayed at particular locations within the interface. Graphical elements may include, but are not limited to, a variety of displayed virtual input devices, including virtual scroll wheels, a virtual keyboard, virtual knobs, virtual buttons, any virtual UI, and the like. A user may perform gestures at one or more particular locations on touch input component 110, which may be associated with the graphical elements of the GUI. In other embodiments, the user may perform gestures at one or more locations that are independent of the locations of graphical elements of the GUI. Gestures performed on a touch input component 110 may directly or indirectly manipulate, control, modify, move, actuate, initiate, or generally affect graphical elements, such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad may generally provide indirect interaction. Gestures may also affect non-displayed GUI elements (e.g., causing user interfaces to appear) or may affect other actions of device 100 (e.g., affect a state or mode of a GUI, application, or operating system). Gestures may or may not be performed on a touch input component 110 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments, in which gestures are performed directly on a touch screen, a user may interact directly with objects on the touch screen, with or without a cursor or pointer being displayed on the touch screen.

Feedback may be provided to the user via bus 114 in response to or based on the touch or near touches on a touch input component 110. Feedback may be transmitted optically, mechanically, electrically, olfactory, acoustically, or the like or any combination thereof and in a variable or non-variable manner.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method for generating graphical object data comprising:
defining input tool content with a plurality of input tool properties;
initially rendering on a display an input tool that is indicative of at least a first input tool property of the plurality of input tool properties;
receiving a multi-touch input gesture;
changing the first input tool property based on the input gesture; and
re-rendering the input tool on the display after the changing.

2. The method of claim 1, wherein:
the display is a touch screen; and
the receiving comprises receiving the multi-touch gesture on the display.

3. The method of claim 2, wherein the receiving further comprises receiving a first touch event of the multi-touch gesture at a position on the display that is shared by the initially rendered input tool.

4. The method of claim 3, wherein the receiving further comprises receiving a second touch event of the multi-touch gesture at a position on the display that is shared by the re-rendered input tool.

5. The method of claim 1, wherein the multi-touch gesture is associated with at least one position on the display where the input tool is initially rendered.

6. The method of claim 1, wherein the multi-touch gesture is associated with at least one position on the display where the input tool is re-rendered.

7. The method of claim 1, wherein at least one position of the multi-touch gesture is independent of any menu provided on the display.

8. The method of claim 1, wherein each position of the multi-touch gesture is independent of any menu provided on the display.

9. The method of claim 1, wherein the multi-touch gesture is a rotate gesture.

10. The method of claim 1, wherein the multi-touch gesture is one of a pinch gesture and a pull gesture.

11. The method of claim 1, wherein the first input tool property defines a visual characteristic of the input tool.

12. The method of claim 11, wherein the first input tool property defines a size of the input tool.

13. The method of claim 11, wherein the first input tool property defines an orientation of the input tool.

14. The method of claim 1 further comprising:
receiving substance information; and
rendering a graphical object on the display based on the substance information and the input tool content.

15. The method of claim 14, wherein the substance information defines a trail along the display.

16. The method of claim 15, wherein the rendering the graphical object comprises applying the input tool content at a first position along the trail.

17. The method of claim 15, wherein the receiving the substance information occurs during the receiving the multi-touch input gesture.

18. The method of claim 15, wherein at least one touch event of the multi-touch gesture generates at least a portion of the substance information.

19. The method of claim 14, wherein the substance information defines a character.

20. The method of claim 19, wherein the rendering the graphical object comprises rendering the character based on the first input tool property.

21. The method of claim 20, wherein the rendering the graphical object further comprises positioning the rendered character on the display at a character position that is dependant on the position of the input tool on the display.

22. The method of claim 14, wherein the rendering the graphical object occurs before the receiving the multi-touch input gesture, before the changing the first input tool property, and before the re-rendering the input tool.

23. A method for generating graphical object data comprising:
defining input tool content based on a plurality of input tool properties;
initially rendering on a display an input tool indicative of at least a first input tool property of the plurality of input tool properties;
receiving an input gesture that is independent of any menu provided on the display;
changing the first input tool property based on the input gesture; and
re-rendering the input tool on the display after the changing.

24. The method of claim 23, wherein the input gesture is associated with at least one position on the display where the input tool is initially rendered.

25. The method of claim 23, wherein the input gesture is associated with at least one position on the display where the input tool is re-rendered.

26. The method of claim 23 further comprising:
receiving substance information; and
rendering a graphical object on the display based on the substance information and the input tool content.

27. The method of claim 26, wherein the substance information defines a trail along the display.

28. The method of claim 26, wherein the substance information defines a character.

29. The method of claim 26, wherein the rendering the graphical object occurs before the receiving the input gesture, before the changing the first input tool property, and before the re-rendering the input tool.

30. The method of claim 23, wherein the changing comprises changing the first input tool property based on the input gesture and changing a second input tool property of the plurality of input tool properties based on the input gesture.

31. The method of claim 30 further comprising:
providing a first menu on the display; and
updating the content of the first menu based on the changing to visually depict how the second input tool property changed.

32. A method for generating graphical object data comprising:
defining input tool content based on a plurality of input tool properties;
initially rendering on a display an input tool that is indicative of at least a first input tool property of the plurality of input tool properties;
receiving an input gesture indicative of at least one position on the display where the input tool is initially rendered;
changing the first input tool property based on the input gesture; and
re-rendering the input tool on the display after the changing.

33. The method of claim 32 further comprising, after the initially rendering but before the re-rendering, rendering a graphical object using the initially rendered input tool, wherein a portion of the display is shared by the rendered graphical object content and the re-rendered input tool.

34. The method of claim 33 further comprising altering a visual characteristic of the re-rendered input tool.

35. The method of claim 34, wherein the altered visual characteristic distinguishes the re-rendered input tool from the rendered graphical object.

36. The method of claim 32, wherein each position associated with the input gesture is independent of any menu provided on the display.

37. The method of claim 32, wherein the input gesture is indicative of at least one position on the display where the input tool is re-rendered.

38. A method of generating a graphical object comprising:
defining input tool content with a plurality of input tool properties;
presenting on a display an input tool indicative of at least a first input tool property of the plurality of input tool properties;
moving the input tool along a trail on the display from a first trail position to a second trail position;
presenting a first portion of the graphical object on the display by applying the input tool content at the first trail position when the input tool is at the first trail position;
presenting a second portion of the graphical object on the display by applying the input tool content at the second trail position when the input tool is at the second trail position; and
changing at least a second input tool property of the plurality of input tool properties during the moving between the first trail position and the second trail position.

39. The method of claim 38, wherein the first input tool property is the second input tool property.

40. The method of claim 38, wherein the first input tool property is a size input tool property.

41. The method of claim 38, wherein the appearance of the first portion of the graphical object differs from the appearance of the second portion of the graphical object due to the changing.

42. The method of claim 38, wherein the defining comprises defining the input tool content as a set of pixel data based on the plurality of input tool properties.

43. The method of claim 38, wherein the moving comprises moving the input tool along the trail in response to receiving a user input gesture on a touch component.

44. The method of claim 43, wherein the user input gesture comprises a user dragging a user touch event along the touch component.

45. The method of claim 44, wherein the changing comprises changing at least the second input tool property in response to the user altering the pressure of the user touch event on the touch component.

46. The method of claim 43, wherein the user input gesture comprises a user dragging two fingers along the touch component.

47. The method of claim 46, wherein the changing comprises changing at least the second input tool property in response to at least one of the user pinching the two fingers during the dragging, the user pulling the two fingers during the dragging, and the user rotating the two fingers during the dragging.

48. A graphical display system comprising:
a display;
an input tool defining module that:
generates input tool content; and
receives a first multi-touch input gesture for changing a first input tool property of the input tool content;
a substance defining module that generates substance content based on substance information and the input tool content; and
a processing module that:
presents on the display an input tool based on the first input tool property; and
presents on the display a graphical object based on the substance content and the input tool content.

49. The system of claim 48, wherein:
the display is a touch screen; and
the input tool receives the first multi-touch gesture from the display.

50. The system of claim 49, wherein a first touch event of the first multi-touch gesture is at a position on the display shared by the input tool presented on the display.

51. The system of claim 48, wherein at least one position of the first multi-touch gesture is independent of any menu on the display.

52. The system of claim 48, wherein each position of the first multi-touch gesture is independent of any menu on the display.

53. The system of claim 48, wherein the first multi-touch gesture is a rotate gesture.

54. The system of claim 48, wherein the first multi-touch gesture is one of a pinch gesture and a pull gesture.

55. The system of claim 48, wherein the first input tool property defines a visual characteristic of the input tool.

56. The system of claim 55, wherein the first input tool property defines a size of the input tool.

57. The system of claim 48, wherein the substance information defines a trail along the display.

58. The system of claim 57, wherein at least one touch event of the first multi-touch gesture generates at least a portion of the substance information.

59. The system of claim 48, wherein the substance information defines a character.

60. Computer-readable media for controlling an electronic device, comprising computer-readable code recorded thereon for:
defining input tool content with a plurality of input tool properties;
initially rendering on a display an input tool that is indicative of at least a first input tool property of the plurality of input tool properties;
receiving a multi-touch input gesture;
changing the first input tool property based on the input gesture; and
re-rendering the input tool on the display after the changing.
